(19) United States
(12) Patent Application Publication
(10) Pub. No.: US 2015/0155009 A1
(43) Pub. Date: Jun. 4, 2015

(54) METHOD AND APPARATUS FOR MEDIA CAPTURE DEVICE POSITION ESTIMATE- ASSISTED SPLICING OF MEDIA

(71) Applicant: Nokia Corporation, Espoo (FI)

(72) Inventors: Sujeet Shyamsundar MATE, Tampere (FI); Junsheng FU, Tampere (FI)

(73) Assignee: Nokia Corporation, Espoo (FI)

(21) Appl. No.: 14/095,569

(22) Filed: Dec. 3, 2013

(51) Int. Cl. G11B 27/036; H04N 21/2743; H04N 21/234

(52) U.S. Cl. CPC G11B 27/036; H04N 21/23424; H04N 21/2743

(57) ABSTRACT

An approach is provided for splicing video segments based on media capture device pose information. The splicing platform may determine at least one first media frame and at least one second media frame. Then, the splicing platform may determine pose information of or at least one media capture device that captured the at least one first media frame, that lest one second media frame, or a combination thereof. Lastly, the splicing platform may process and/or facilitate a processing of the pose information to determine one or more intermediate media frames for insertion between the at least one first media frame and the at least one second media frame.

### BACKGROUND

Service providers and device manufacturers (e.g., wireless, cellular, etc.) are continually challenged to deliver value and convenience to consumers by, for example, providing compelling network services. One area of interest has been the development of offering ways to manipulate media. For example, with the influx of media capture devices (i.e., cameras, video cameras, audio recorders, etc.), media capture is increasingly common. Media editing services are also popular, where users may splice together disparate pieces of media. However, the splicing of two disjoint pieces of media often results in a discontinuity, for instance, showing a spatial and temporal gap between the two pieces of media that are being joined. This means that the splicing may look disruptive or disjointed. At the same time, geo-localized media is becoming almost ubiquitous, given increasing coverage of street view maps, for instance. In other words, information regarding the exact positions of images or positions at which images were captured, is often available. However, splicing media does not incorporate position information regarding media capture. Therefore, content providers face challenges in permitting smooth transitions in splicing of media.

### Some Example Embodiments

Therefore, there is a need for an approach for splicing video segments based on media capture device pose information.

According to one embodiment, a method comprises determining at least one first media frame and at least one second media frame. The method also comprises determining pose information for at least one media capture device that captured the at least one first media frame, the at least one second media frame, or a combination thereof. The method further comprises processing and/or facilitating a processing of the pose information to determine one or more intermediate media frames for insertion between the at least one first media frame and the at least one second media frame.

According to another embodiment, an apparatus comprises at least one processor, and at least one memory including computer program code for one or more computer programs, the at least one memory and the computer program code configured to, with the at least one processor, cause, at least in part, the apparatus to determine at least one first media frame and at least one second media frame. The apparatus is also caused to determine pose information for at least one media capture device that captured the at least one first media frame, the at least one second media frame, or a combination thereof. The apparatus is further caused to process and/or facilitate a processing of the pose information to determine one or more intermediate media frames for insertion between the at least one first media frame and the at least one second media frame.

According to another embodiment, a computer-readable storage medium carries one or more sequences of one or more instructions which, when executed by one or more processors, cause, at least in part, an apparatus to determine at least one first media frame and at least one second media frame. The apparatus is also caused to determine pose information for at least one media capture device that captured the at least one first media frame, the at least one second media frame, or a combination thereof. The apparatus is further caused to process and/or facilitate a processing of the pose information to determine one or more intermediate media frames for insertion between the at least one first media frame and the at least one second media frame.

According to another embodiment, an apparatus comprises means for determining at least one first media frame and at least one second media frame. The apparatus also comprises means for determining pose information for at least one media capture device that captured the at least one first media frame, the at least one second media frame, or a combination thereof. The apparatus is further comprises means for processing and/or facilitating a processing of the pose information to determine one or more intermediate media frames for insertion between the at least one first media frame and the at least one second media frame.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of splicing video segments based on media capture device pose information, according to one embodiment;

FIG. 2A is a diagram of the components of a splicing platform, according to one embodiment;

FIG. 2B is a diagram of the components of a segment module, according to one embodiment;

FIG. 3 is a flowchart of a process for splicing video segments based on media capture device pose information, according to one embodiment;

FIG. 4 is a flowchart of a process for determining pose trajectory information, according to one embodiment;

FIG. 5 is a flowchart of a process for determining the frequency for calculating the pose information, according to one embodiment;

FIG. 6 is a flowchart of a process for determining contextual information, according to one embodiment;

FIGS. 7A-7C are diagrams of use cases, according to one embodiment;

FIG. 7D is a diagram of a splice media sampling curve, according to one embodiment;

FIG. 8 is a diagram of elliptical model of the earth utilized in the process of FIGS. 3-6, according to one embodiment;

FIG. 9 is a diagram of an earth centered, earth fixed (ECEF) Cartesian coordinate system utilized in the process of FIGS. 3-6, according to one embodiment;

FIG. 10 illustrates a Cartesian coordinate system (CCS) 3D local system with its origin point restricted on earth and three axes (X-Y-Z) utilized in the process of FIGS. 3-6, according to one embodiment;

FIG. 11 is a diagram of a geo video data utilized in the process of FIGS. 3-6, according to one embodiment;

FIG. 12 is a diagram of a camera orientation in a 3D space utilized in the process of FIGS. 3-6, according to one embodiment;

FIG. 13 is a diagram of a camera pose in CCS_{—}3D_ECEF utilized in the process of FIGS. 3-6, according to one embodiment;

FIGS. 14-22 are diagrams of user interfaces utilized in the processes of FIGS. 3-6, according to various embodiments;

FIG. 23 is a diagram of hardware that can be used to implement an embodiment of the invention;

FIG. 24 is a diagram of a chip set that can be used to implement an embodiment of the invention; and

FIG. 25 is a diagram of a mobile terminal (e.g., handset) that can be used to implement an embodiment of the invention.

### DESCRIPTION OF SOME EMBODIMENTS

Examples of a method, apparatus, and computer program for splicing media segments based on media capture device pose information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

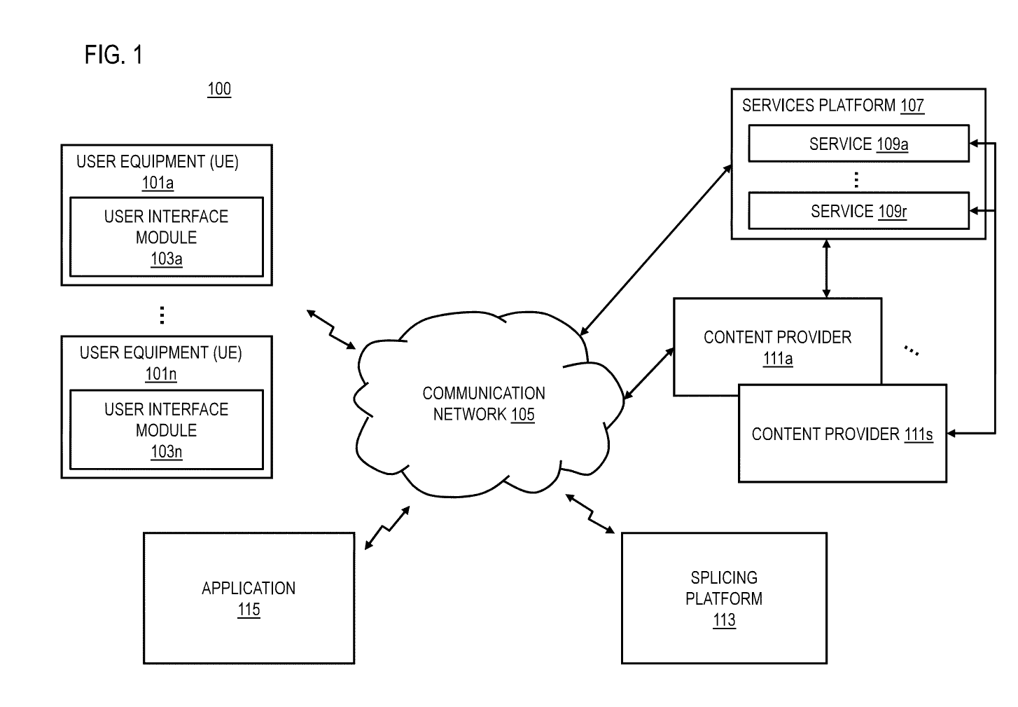

FIG. 1 is a diagram of a system capable of splicing media segments based on media capture device pose information, according to one embodiment. Service providers and device manufacturers (e.g., wireless, cellular, etc.) are continually challenged to deliver value and convenience to consumers. One area of interest has been the development of offering ways to manipulate media. Media capture and editing is increasingly popular and common. However, the splicing of two disjoint pieces of media often results in a discontinuity that is often visually unappealing or simply leaves a gap in information. For instance, splicing may display a spatial and temporal gap between the two pieces of media. Meanwhile, geo-localized media is also available, where information regarding the exact positions of images or positions at which images were captured, is often known. However, splicing media does not incorporate position information regarding media capture. Therefore, content providers face challenges in permitting smooth transitions in splicing of media.

To address this problem, a system 100 of FIG. 1 introduces the capability to splice media segments based on media capture device pose information, according to one embodiment. Media segments may include image, video, audio files, or a combination thereof. Media capture devices may include cameras, microphones, camcorders, sensors, or a combination thereof. In this embodiment, media capture device pose information may include information regarding the positioning of a media capture device in capturing a given media segment. For example, pose information may include location coordinates, general locations or regions, tilt angle, field of view, depth of field, height at which the capture was taken, etc. In one embodiment, the system 100 may determine two disjoint media segments, for instance, video segments. Typically, transitioning between two disjoint video segments causes an abrupt scene change. This creates a disruption where two segments are spliced. However, system 100 may create a smooth transition with images and/or audio with a common and/or substantially overlapping view to bridge the two disjointed segments. In one embodiment, such “common view” switch points may be especially useful for browsing of hyperlinked media in a continuous fashion.

In addition, the transition created by system 100 may offer a journey, for example, a journey following a route or path. In one such embodiment, the system 100 may determine a start location and end location, where the system 100 determines media capture device pose information associated with the start and end locations, then creates a visual and/or audio experience showing what it would look like to travel from the start location to the end location. In essence, the system 100 may create a visual and/or audio experience that offers a smooth transition between two media segments that may be spatially and/or temporally separate. For instance, two media segments may be at different locations and/or show different times. The system 100 may determine, find, and/or create intermediate frames to fit between the two media segments so that the transition between two media segments is smoother.

To do so, the system 100 may employ various methods to ensure that the intermediate frames are meaningful, meaning that they fit the context of the start and end media segments. In one embodiment, system 100 ensures that the intermediate frames match both start and end media segments and/or sequences. For example, a first media segment may include a frame that is to be spliced to a frame of a second media segment. The frame of the first media segment may be the “start” media frame and the frame of the second media segment may be the “end” media frame. For instance, the “start” media frame may be the last frame of a first video segment, and the “end” media frame may be the first frame of a second video segment that is to be spliced to the first media segment. In another instance, the “start” and “end” frames may be in between disparate video segments, or even part of the same video segment. For example, there could be multiple “start” and “end” frames in creating an overall media composition. For clarity, the term, “first frame” or “first media frame” will correspond to a “start” frame. “Second frame” or “second media frame” may correspond to an “end” frame. A first video segment may yield a first frame while a second frame may be from another video. Alternately, the first frame and second frame may be from the same video. In any case, a first frame is the frame from which a splice is to begin, while a second frame is the ending frame of a splice.

In one embodiment, the system 100 may determine pose information associated with the first media frame and the second media frame. In one embodiment, the system 100 may calculate the pose information. In another embodiment, the system 100 may retrieve position information, for instance, as metadata associated with media frames. Then, the system 100 may calculate a set of pose information that spans the interval between the first frame and the second frame. For instance, if a first frame has pose information at location coordinates (x, y) and a second frame has pose information at location coordinates (x, z), the system 100 may determine a set of pose information that falls between location coordinates (x, y) and (x, z). In one case, the pose information may be with respect to a global coordinate system based on an Earth centered Earth Fixed (ECEF) global coordinate system. However, embodiments are applicable to any global coordinate system for identifying locations. For example, other applicable global coordinate systems include, but are not limited to, a world geodetic system (WGS84) coordinate system, a universal transverse Mercator (UTM) coordinate system, and the like.

The system 100 may derive pose information from sensors associated with devices used to capture the frames. Such sensors may include, for example, a global positioning sensor for gathering location data, a network detection sensor for detecting wireless signals or network data, temporal information and the like. In one scenario, the sensors may include location sensors (e.g., GPS), light sensors, orientation sensors augmented with height sensor and acceleration sensor, tilt sensors, moisture sensors, pressure sensors, audio sensors (e.g., microphone), or receivers for different short-range communications (e.g., Bluetooth, WiFi, etc.). The sensors may work in conjunction with a service that correlates point(s) selected within a frame to find pose information associated with that image. For example, the service may contain or have access to images with corresponding pose information and reconstructed 3D point clouds defined within, for instance, a local 3D Cartesian coordinate system (CCS_{—}3D_Local system) with known origin and axes. Media capture device poses and point clouds can be uniquely mapped to a 3D ECEF Cartesian coordinate system (CCS_{—}3D_ECEF) or other global coordinate system (e.g., WGS84, UTM, etc.). In one scenario, the service may determine an area that matches the point cloud, and then calculating the perspective of the video to get pose information. Performing this process on a frame by frame basis may give indication to movement of a media capture device. T system 100 may determine media content corresponding to the set of pose information. In one embodiment, the system 100 may then insert the media content in between the first frame and the second frame to join the video segment(s) from which the first frame and second frame derive.

In one embodiment, the system 100 is capable of automatically locating the camera pose for each frame in a global coordinate system, thereby when a user uploads a video, the system 100 knows exactly where it was taken and the accurate camera position of each video frame. In another embodiment, the system 100 may process the image data to obtain Global Positioning System (GPS) information associated with the image. In one embodiment, the system 100 may track images, match the images and extract 3D information from the images and then translate the 3D information to the global coordinate system. Further, the system 100 may extract geo location metadata from the collection of images or sequences of video frames.

In one embodiment, system 100 processes one or more images to determine camera location information and/or camera pose information, wherein these information are represented according to a global coordinate system, thereby causing, at least in part, an association of these information with the one or more images as meta-data information. As previously noted, the example embodiments described herein are applicable to any global coordinate system and it is contemplated that embodiments of the system 100 apply equally to ECEF, WGS84, UTM, and the like. By way of example, like ECEF, a WGS 84 coordinate system provides a single, common, accessible 3-dimensional coordinate system for geospatial data collected from a broad spectrum of sources. WGS 84 is geocentric, whereby the center of mass is being defined for the whole Earth. Similarly, a UTM coordinate system is a global coordinate projection system using horizontal position representation.

In one embodiment, the splicing in system 100 will comprise media content all of one type. For example, the system 100 may create a splicing of video and/or image frames between two video segments. In another embodiment, system 100 splicing may include various types of media. For example, system 100 may splice video segments and also splice in audio for portions where audio is faulty. In other words, the splicing in system 100 may overlap for various forms of media. For audio content, system 100 may take into account pose information, for instance, pose information based on the orientation of a microphone. In another embodiment, the system 100 may splice together media with a range of pose information, adding on to the pose information determined based on the first and second frame. For instance, the system 100 may calculate four points of pose information based on the first and second frame. Then, the system 100 may introduce a range of pose information at each of the four points and find images corresponding to the range at each of the four points. Then, the system 100 may stitch the images together to form a wider angle or panoramic view for the spliced segment.

In one embodiment, the system 100 may further supplement position information with other information in selecting media content to serve as intermediate media frames between the first frame and second frame. For example, the system 100 may employ pose trajectory information and/or contextual information. In one embodiment, pose trajectory information may include a specific path trajectory that joins the first media frame and second media frame. For example, system 100 may access map data associated with pose information associated with the first frame and the second frame. Then, for instance, system 100 may determine that the map data indicates that the pose information follows a pedestrian path rather than a motorway. In doing so, system 100 may then select intermediate frames pertaining to the pedestrian path rather than the motorway, in order to fill in a transition that corresponds to the first and second frame. In one embodiment, the first and second frame may represent portions of missing content. For example, a user may wish to recreate video over an entire marathon route, but video may not be available for portions of the route. Then, system 100 may identify the unavailable portions as points where insertion of intermediate frames is necessary and thus select intermediate frames based on a published marathon route to form a complete video.

Contextual information may include spatial information, temporal information, information regarding recognized objects, or a combination thereof. For example, spatial information may include accounting for a field of view or focus in the first frame and second frame, and selecting intermediate frames based on those fields of view. Temporal information may include, for instance, time of day or event. For example, system 100 may determine that the first and second frames were both captured at nighttime. Then, system 100 may retrieve intermediate frames with lighting indicative of also being taken at nighttime. In another example, the temporal information may indicate a certain season so that retrieved intermediate frames correspond to that season. This way, the transition between the first and second frame will be inconspicuous. Events in temporal information, may include, for instance, determining that the first and second frame are associated with an event. For example, the first and second frame may be from a marathon. Then, system 100 would select intermediate frames also taken during the marathon, rather than inserting intermediate frames showing a road under usual conditions.

Contextual information may further include information regarding recognized objects. For instance, recognized objects may include people, where a user may wish to insert intermediate frames with his family included, rather than any intermediate frames that fit the pose information. In one case, positioning of the recognized objects within a frame may also be taken into account. For example, system 100 may select and/or organized intermediate frames so that recognized objects move in a sensible pattern or path from the first frame to the second frame, rather than shifting abruptly.

In one embodiment, the system 100 media content for the intermediate media frames may include media from at least one database of registered media. For instance, media from various sources (i.e., different users, stock images, sound clips and samples, or footage, historical footage, etc.) may be registered at a repository to which system 100 has access. More specifically, the database may be particular to media that has associated location information, for example, location-registered media. The database may contain media that is geotagged. In addition, the database may categorize media based on location to facilitate retrieval of media based on pose information. In one scenario, the media and/or database may be globally-registered so that its existence is known from any service. In other words, any service requiring a particular piece of media that corresponds to pose information of interest may see that a globally-registered media is in existence. In some cases, the globally-registered media is also available. In other cases, the service may undergo some form of authorization before it may retrieve the media for the pose information. However, global registration may permit services and users awareness of the presence of the media and database.

In one embodiment, the database may further augment metadata of registered media. For example, the database may augment geocoordinate-tagged video using location information of POIs proximate coordinates of various frames. By way of example, the database may include videos geotagged based on the output of an ECEF coordinate tagging engine. The database may further tag panorama images with GPS information (e.g., latitude and longitude in a 2D geographic coordinate system (GCS_{—}2D)), and augment pose information of frames based on the pose information or geotags of nearby panorama images. The database may reconstruct metadata associated with registered media within a CCS_{—}3D_ECEF system in order to integrate media of various pose information that may be captured at different locations, time and by different people.

Then, system 100 may contact the repository or database when intermediate media frames are necessary to find media frames that fit requisite pose information. In another embodiment, the system 100 may synthesize media frames based on pose information and/or other criteria determined within system 100. For example, the system 100 may access augmented reality models, maps, and/or insert selected objects into media frames in order to generate intermediate frames. Augmented reality models and maps, for instance, may include frames that resemble settings with pose information associated with a first and second frame. Selected objects may include, for instance, people, where system 100 may have intermediate frames from a database with requisite pose information, then insert characters present in the first and second frame so that the transition between the first and second frame are fluid. Images and or sounds that correspond to those characters and people may be drawn from another database, in one scenario.

In splicing video segments based on media capture device pose information, the system 100 may provide a better viewing experience for edited videos. For example embodiment, the system 100 may provide a smooth perspective when switching between view angles, for instance, from media capture devices with disjoint field of views or media capture devices that are far from each other. Also, system 100 may be used to stitch together user contributed videos to re-construct a scene. As previously discussed, reconstructing such a scene may include video media and/or audio media. In another embodiment, the system 100 may provide a “complete picture” that can be used for navigational aid. For instance, the first frame may be a starting point and the second frame may be a destination. Then, the system 100 may create the path between the first and second frame to give a user a full visual of his route. In another embodiment, the system 100 may create an experience of seamless media browsing. For example, system 100 may enable seamless hyperlinking of media to create hypermedia browsing.

As shown in FIG. 1, the system 100 comprises a user equipment (UE) 101a-101n (or UEs 101) having connectivity to user interface modules 103a-103n (or user interface modules 103), a services platform 107 comprised of services 109a-109r (or services 109), content providers 111a-111s (or content providers 111), a splicing platform 113, and an application 115 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the user interface module 103 may provide information regarding settings for splicing. For example, the user interface modules 103 may prompt users to select various settings for where to splice in points, what services to sample intermediate frames from, content information to note, and the duration of a spliced in segment. For instance, user interface modules 103 may present two videos and permit a user to select, with a cursor action, the first frame and the second frame which a user wishes to splice together. Then, the user interface modules 103 may present a list of services 109 and/or content providers 111 from which intermediate frames may be created or selected. In one embodiment, other UEs 101 may also serve as a source of intermediate frames. For example, the system 100 may build intermediate frames from crowd sourced media. For content information, user interface modules 103 may, for instance, permit users to select in the first and/or second frame, objects within the frames that must be present in intermediate frames. For example, user interface modules 103 may permit users to highlight a person and/or structure that may inform selection of intermediate frames. The duration of a spliced segment may also be set by a user via the user interface modules 103. This duration may affect, for instance, the number of intermediate frames needed and the frequency at which they are inserted between a first and second frame. The user interface modules 103 may further present a previous of the spliced segment for user approval and/or editing.

In one embodiment, the services platform 107 may provide services 109 that offer registered media content that is tagged with pose information. In one embodiment, content providers 111 may be another source of such media content. In a further embodiment, services 109 may further include services to generate intermediate frames, for instance, synthesizing intermediate frames using augmented reality and/or map data. In another further embodiment, services 109 and/or content providers 111 may provide map data that can be used for determining pose trajectory information. For example, services 109 and/or content providers 111 may have map data that permits system 100 to determine that pose trajectory information for given frames follows a path associated with a certain mode of transport. Then, system 100 may determine pose information and intermediate frames from that path associated with the mode of transport.

In one embodiment, the splicing platform 113 may determine the splicing of media segments based on media capture device pose information. For example, the splicing platform 113 may determine, from user interface modules 103, a request to splice media. Then, the splicing platform 113 may determine the interval across which splicing must occur by identifying the first frame and second frame. The splicing platform 113 may determine pose information associated with the first frame and second frame, either from metadata associated with the frames and/or by engaging services 109. In one embodiment, the splicing platform 113 may then retrieve, from the services platform 107 and/or content providers 111, intermediate frames that correspond to pose information associated with the first frame and second frame. Afterwards, the splicing platform 113 may link the frames together to form the splicing. In one embodiment, the splicing platform 113 may also be implemented in a peer-to-peer approach, a single device application approach or a client-server approach.

In one embodiment, the application 115 may serve as the means by which the UEs 101 and splicing platform 113 interacts. For example, the application 115 may activate upon user request or upon detection that media content is incongruous. For example, application 115 may offer recommendations where media is unavailable, for instance, where audio is missing from a segment of video.

By way of example, the UE 101, user interface modules 103, services platform 107 with services 109, content providers 111, splicing platform 113, and application 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

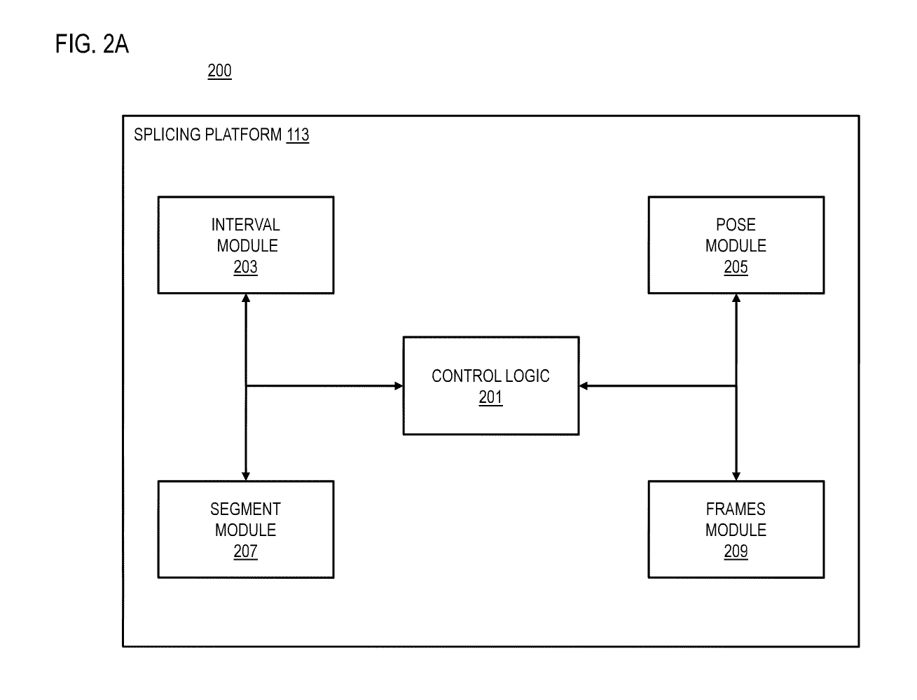

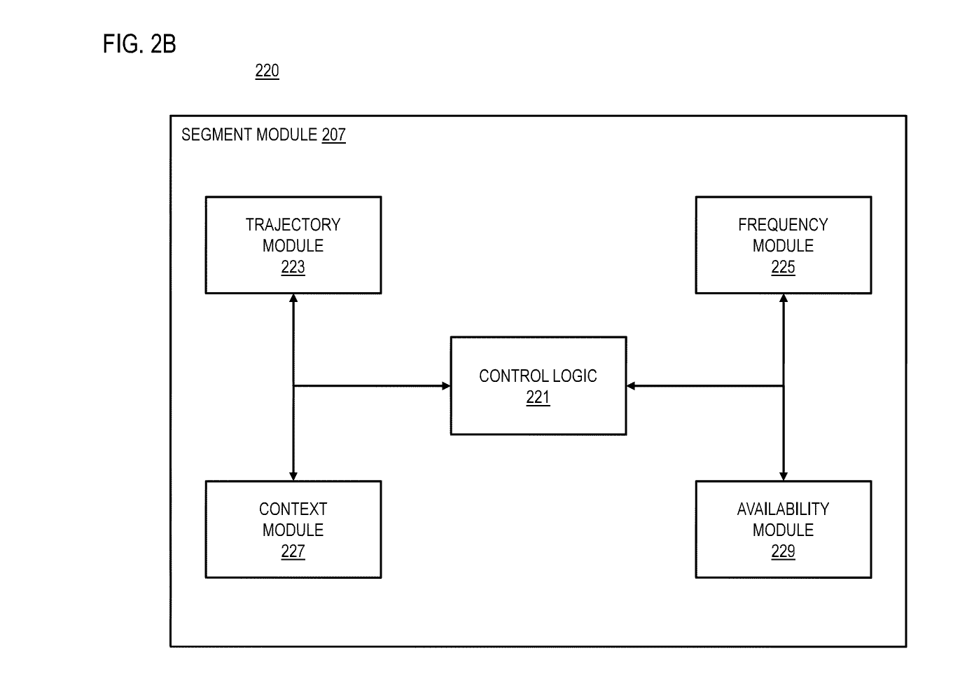

FIG. 2A is a diagram of the components of the splicing platform 113, according to one embodiment. By way of example, the splicing platform 113 includes one or more components for splicing video segments based on media capture device pose information. It is contemplated that the functions of these components may be combined in one or more components or performed by other components of equivalent functionality. In this embodiment, the splicing platform 113 includes a control logic 201, an interval module 203, a pose module 205, a segment module 207, and a frames module 209.

In one embodiment, the control logic 201 and interval module 203 may detect and determine a first media frame and a second media frame. For example, the control logic 201 and interval module 203 may determine one or more segments of media. In one instance, the segments of media may include video snippets, full videos, audio clips or files, etc. The segments of media may further include media sequences. For example, a video snippet may be broken down into a sequence of media frames or images. Out of a video file, for example, the control logic 201 and interval module 203 may determine two frames between which splicing must occur. For example, the control logic 201 and interval module 203 may identify two parts of a video that a user may want to splice together. In one embodiment, the two parts may be media sequences from different video files. Alternately, the two parts may be various sections of one video file. A user may simply want to cut some parts out but smoothly join remaining parts of the video in order to manage pacing or flow of a storyline, for instance.

In one embodiment, the control logic 201 and interval module 203 essentially determine the interval across which intermediate media frames are to span. For example, the control logic 201 and interval module 203 may select a first media frame and a second media frame. The first media frame and second media frame may be the starting point and the end point of an interval for which the control logic 201 is providing a continuous media clip to smooth the transition from the first media frame to the second media frame.

In one embodiment, the control logic 201 and pose module 205 may determine the media capture pose information of media frames. For example, the control logic 201 and pose module 205 may determine media capture pose information comprised of camera pose information. Such information may include determining the tilt, zoom, orientation, location coordinates, etc. of a camera in capturing a media sample. For instance, the control logic 201 and pose module 205 may determine that a first media image was taken with a tilt of 25° of a camera a set of pose information. A second media image may be taken with a tilt of 75° of a camera and the same set of pose information. Then, the splicing platform 113 must provide intermediate frames to make the transition from the first media image to the second media image. As in the previous discussion, the media images may be media frames that are part of either video and/or audio segments.

In one embodiment, the control logic 201 and pose module 205 may further determine pose information of various media available from a database. For instance, the control logic 201 and pose module 205 may poll a database for media frames that fall between the first media frame and second media frame, as given by pose information of the media frames in the database and the first and second media frames. For example, the control logic 201 and pose module 205 may determine a range of pose information from which frame intermediate to the first and second media frames can be found.

In one embodiment, the control logic 201 and segment module 207 may determine various criteria by which to find one or more intermediate media frames for insertion between a first media frame and a second media frame. For example, segment module 207 may determine pose trajectory information, frequency at which intermediate media frames are to be inserted, contextual information, or a combination thereof. The control logic 201 and pose module 205 ensure that positioning of intermediate frames matches the splicing that must occur, while control logic 201 and segment module 207 ensures that the content of the frames corresponds to the first and second frames.

In one embodiment, the control logic 201 and frames module 209 may determine frames that fit the criteria set out by the control logic 201 and segment module 207. For instance, the control logic 201 and frames module 209 may be the modules that contact and/or track registered media. For example, at least one database may store a collection of registered media. For example, the control logic 201 may access such a database via the services platform 107 and/or content providers 111. In other words, the services platform 107 may provide services 109 that contain or permit access to registered media. Likewise, content providers 111 may also serve as a source of such media.

The control logic 201 and frames module 209 may select, out of the collection of media, intermediate media frames that may fit the interval between a first media frame and second media frame, based on pose information. In another embodiment, the control logic 201 and frames module 209 may further synthesize media frames based on pose information. For example, the control logic 201 and frames module 209 may interact with services 109 of the services platform 107 to generate media frames. For example, the control logic 201, pose module 205, and segment module 207 may inform the control logic 201 and frames module 209 of pose information to make the transition between the first frame and second frame. The control logic 201 and frames module 209 may then rely on various database information and/or context information to create and synthesize one or more intermediate frames. For example, the control logic 201 and frames module 209 may implement augmented reality and/or available three-dimensional map images to generate one or more intermediate frames.

FIG. 2B is a diagram of the components of the segment module 207, according to one embodiment. By way of example, the segment module 207 includes one or more components for providing criteria for selecting and/or generating intermediate media frames. It is contemplated that the functions of these components may be combined in one or more components or performed by other components of equivalent functionality. In this embodiment, the segment module 207 includes a control logic 221, a trajectory module 223, a frequency module 225, a context module 227, and an availability module 229.

In one embodiment, the control logic 221 and the trajectory module 223 may determine pose trajectory information for media sequences associated with the first and second media frame. For example, the transition between the first and second media frame may follow one or more paths. For instance, the first and second media frame may be images taken at different points along a road. For example, the first media frame may be a frame at a 5-mile mark of a highway and a second media frame may be at a 15-mile mark of the same highway. Then, the control logic 221 and trajectory module 223 may determine the pose trajectory information for such a situation as being comprised of pose information along the highway, the highway being the basis of the trajectory. In another embodiment, the control logic 221 and trajectory module 223 may determine the pose trajectory information as any given course or sequence between the first and second media frames. For example, the control logic 221 and trajectory module 223 may determine a path between the first and second media frames to be a most direct path or an indirect path, where the control logic 221 and trajectory module 223 may further define that path. For instance, if pose information includes a first frame with pose information including a camera being pointed to an orientation facing 90° and a second frame with pose information indicating that the camera is pointed facing 270°, the control logic 221 and trajectory module 223 may determine the trajectory to follow a panning of 180° (a direct path), or a panning of 540° (an indirect path).

In one embodiment, the control logic 221 and trajectory module 223 may determine mode of transport information associated with pose trajectory information. For example, various modes of transport (bus, personal vehicle, bike, walking, etc.) may follow different paths. The control logic 221 and trajectory module 223 may determine a mode of transport associated with pose information and/or pose trajectory information associated with the first media frame, second media frame, first media sequence, second media sequence, or a combination thereof. Then, the control logic 221 and trajectory module 223 may determine for the pose trajectory information to follow or be based on the mode of transport associated with the frames and/or sequences. For example, the control logic 221 and trajectory module 223 may determine that pose information and/or pose trajectory information for a first frame and a second frame appear to be associated with a bike path. Then, the control logic 221 and trajectory module 223 may determine mode of transport information associated with a bike and/or bike path. In doing so, the control logic 221 and trajectory module 223 may cause intermediate frames to be based on or incorporate the bike path, rather than, for instance, a vehicle lane adjoining the bike path.

In one embodiment, the control logic 221 and the frequency module 225 may determine the number and frequency of intermediate frames necessary or wanted to create a the transition between the first and second media frames. For example, the control logic 221 and frequency module 225 may determine that a really smooth transition is desirable for a splicing assignment. Then, the control logic 221 and frequency module 225 may determine that more intermediate frames are needed to fill the interval between the first frame and second frame. Then, the control logic 221 and frequency module 225 may determine the rate of frames for intermediate frames to be inserted between the first and second frame, as well as the number of frames needed. In one embodiment, the frequency may not be constant. For example, the control logic 221 and frequency module 225 may determine intermediate frames to be inserted at regular time intervals between the first and second frame. Alternately, the control logic 221 and frequency module 225 may determine for intermediate frames to have a high frequency of insertion close to the first frame and close to the second frame, but frequency might be low in between. The high frequency close to the first and second frame may create a smoother transition, whereas the lower frequency in between may account for file limitations or simply not needing as many frames to fill the interval.

In one embodiment, the control logic 221 and context module 227 may determine contextual information associated with first and/or second media frames. Contextual information may include metadata associated with a frame. For example, the control logic 221 and context module 227 may determine contextual information, including spatial information, temporal information, information regarding recognized objects, or a combination thereof. For example, spatial information may include, for instance, a level of zoom or a field of view. Spatial information may be comprised of the composition or total scene in a frame. Temporal information may include a timing of a frame. For example, if the first and second media frames appear to have a lighting that reflects temporal information approximating dusk, the control logic 221 and context module 227 may designate a selection of intermediate media frames that pertain to dusk. In one scenario, even if spatial information and arrangement of intermediate media frames align with transition from the first frame to the second frame, lighting in the frame must be taken into account to ensure that the transition is believable. Temporal information may contribute to assuring such a transition.

Information regarding recognized objects may include, for example, noting metadata, for instance, “rain” or “high tide” or “festival.” For instance, if the first frame and second frame were taken during rainy weather, some circumstances may require that intermediate frames also depict rain in order to believable fit between the first and second frames. Even if the right locations are involved, splicing the first and second frames may still be choppy unless the control logic 221 and context module 227 take into account objects within frames. Likewise, various events may affect selection or synthesizing of intermediate frames. For instance, a setting may look different whether or not a festival is occurring at the setting. Then, the control logic 221 and context module 227 may account for a festival temporal information and/or recognized object information in generating the intermediate frames. The control logic 221 and context module 227 may further apply such object recognition to people and/or items in a frame. For instance, the control logic 221 and context module 227 may determine that specific subjects are common between the first and second media frames. Then, the control logic 221 and context module 227 may identify that intermediate frames must contain the specific subjects. Furthermore, the control logic 221 and context module 227 may note the positioning of the recognized objects with the first frame and second frame, and cause selection of intermediate frames such that positioning of the recognized objects within the intermediate frames forms a logical transition for splicing the first and second frames together.

In one embodiment, the control logic 221 and availability module 229 may determine the availability of one or more intermediate media frames. For example, one or more frames may not be available for the criteria set by the control logic 221, trajectory module 223, frequency module 225, and/or context module 227. Then, the control logic 221 and availability modules 229 may prompt a change to criteria of the trajectory module 223, frequency module 225, and/or context module 227. In another embodiment, the availability module 229 may contact services 109 and/or content providers 111 to synthesize intermediate media frames and/or find more database resources that may provide intermediate frames to satisfy the criteria.

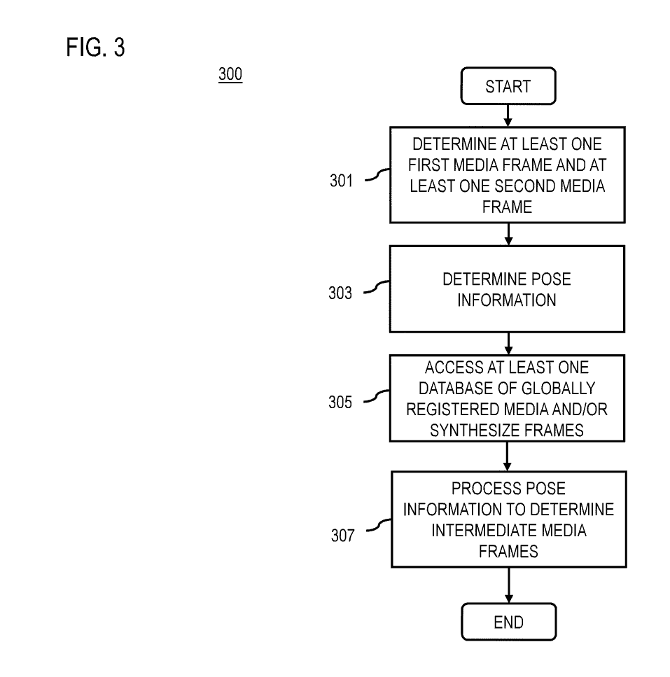

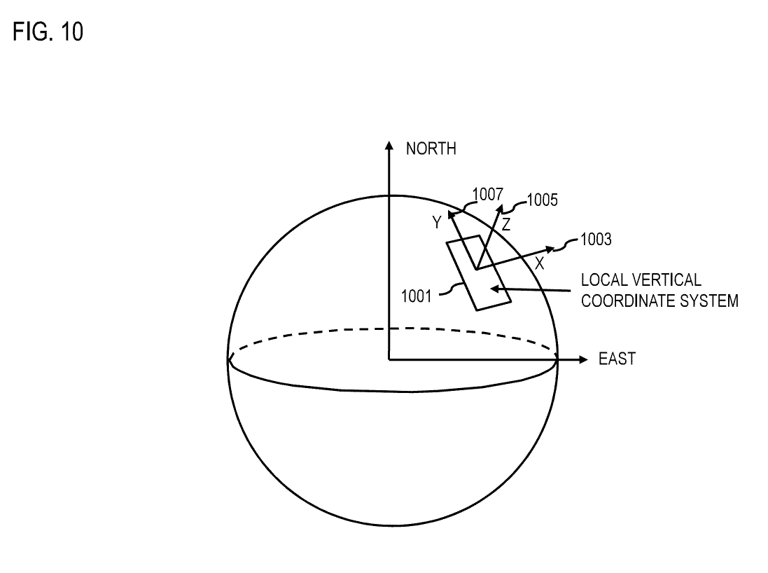

FIG. 3 is a flowchart of a process for splicing video segments based on media capture device pose information, according to one embodiment. In one embodiment, the control logic 201 performs the process 300 and is implemented in, for instance, a chip set including a processor and a memory as shown in FIG. 10. In step 301, the control logic 201 determine at least one first media frame and at least one second media frame. In one embodiment, the at least one first media frame, that least one second media frame, or a combination thereof includes, at least in part, one or more video frames, one or more audio frames, or a combination thereof. In one embodiment, the control logic 201 determines the media frames wherein the at least one first media frame, the at least one second media frame, or a combination thereof is an end media frame, a start media frame, or a combination thereof.

Then in step 303, the control logic 201 may determine pose information for at least one media capture device that captured the at least one first media frame, the at least one second media frame, or a combination thereof. In one embodiment, the control logic 201 may determine the one or more intermediate media frames from at least one database of registered media. Alternately, the control logic 201 may cause, at least in part, a synthesizing of the one or more intermediate media frames based, at least in part, on the pose information (step 305). In one embodiment, the control logic 201 may process and/or facilitate a processing the pose information to determine one or more intermediate media frames for insertion between the at least one first media frame and the at least one second media frame (step 307).

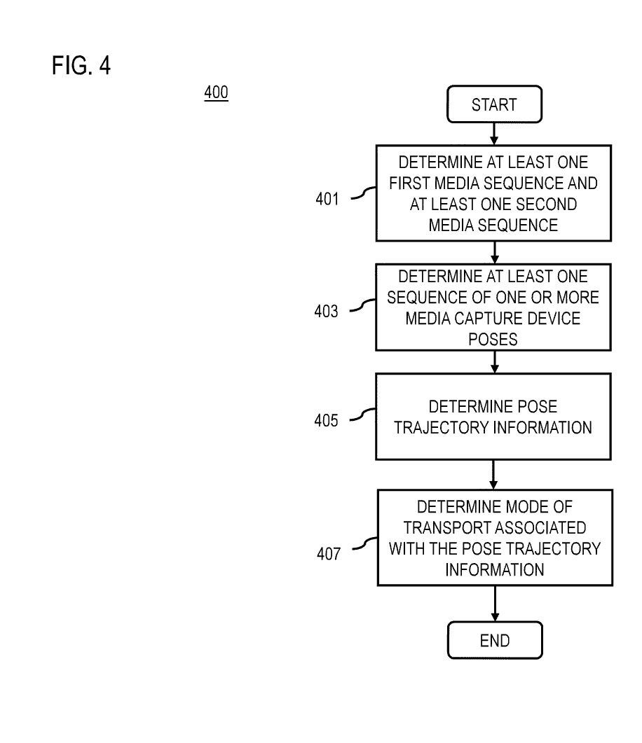

FIG. 4 is a flowchart of a process for determining pose trajectory information, according to one embodiment. In one embodiment, the control logic 221 performs the process 400 and is implemented in, for instance, a chip set including a processor and a memory as shown in FIG. 10. In steps 401 and 403, the control logic 221 may determine at least one first media sequence, at least one second media sequence, or a combination thereof. In step 403, the control logic 221 may determine at least one sequence of one or more media capture device poses. For example, for step 405, the control logic 221 may determine pose trajectory information for at least one first media sequence associated with the at least one first media frame, at least one second media sequence associated with the at least one second media frame, or a combination thereof, wherein the pose trajectory information represents at least one sequence of one or more media capture device poses estimated over the at least one media sequence, the at least one second media sequence, or a combination thereof and wherein the one or more intermediate frames are further determined based, at least in part, on the pose trajectory information. For step 407, the control logic 221 may determine mode of transport information associated with the pose trajectory information the pose information, or a combination thereof, wherein the one or more intermediate media are further determined base, at least in part, on the mode of transport information.

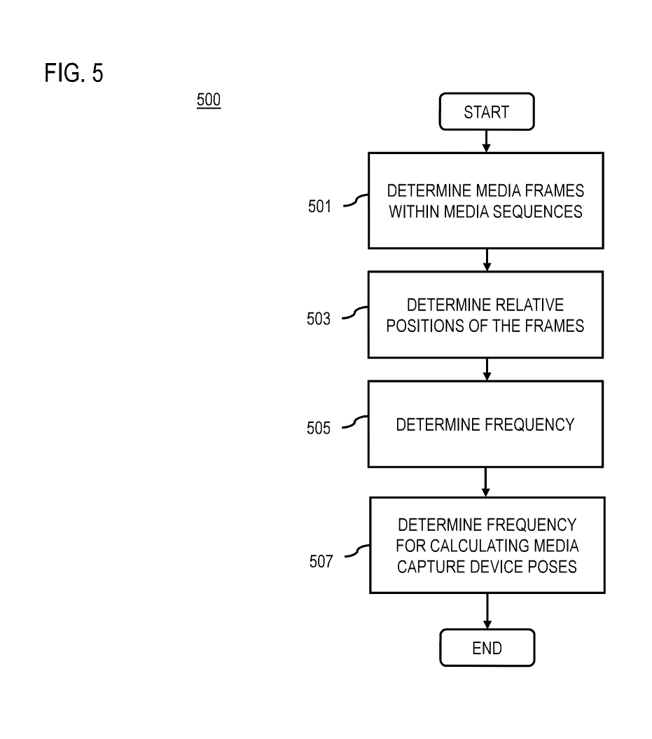

FIG. 5 is a flowchart of a process for determining the frequency for calculating the pose information, according to one embodiment. In one embodiment, the control logic 221 performs the process 500 and is implemented in, for instance, a chip set including a processor and a memory as shown in FIG. 10. For step 501, the control logic 221 may determine media frames within media sequences. Then for step 503, the control logic 221 may determine relative positions of at least one first media frame and a second media frame. In one embodiment, step 505 may include determining a frequency. For example, the control logic 221 may maintain and/or generate several default frequencies and/or models of frequencies. For instance, the frequencies may be constant and/or vary within a given time interval. Then for step 507, the control logic 221 may determine frequency for calculating the pose information based on relative positions of media frames. This may mean that the control logic 221 may determine a frequency given the pose information specifically for the first media frame and second media frame. For example, the control logic 221 may determine at least one frequency for calculating the pose information based, at least in part, on one or more relative positions of (a) the at least one first media frame within the at least one first media sequence, (b) the at least one second media frame within the at least one second media sequence, or (c) a combination thereof.

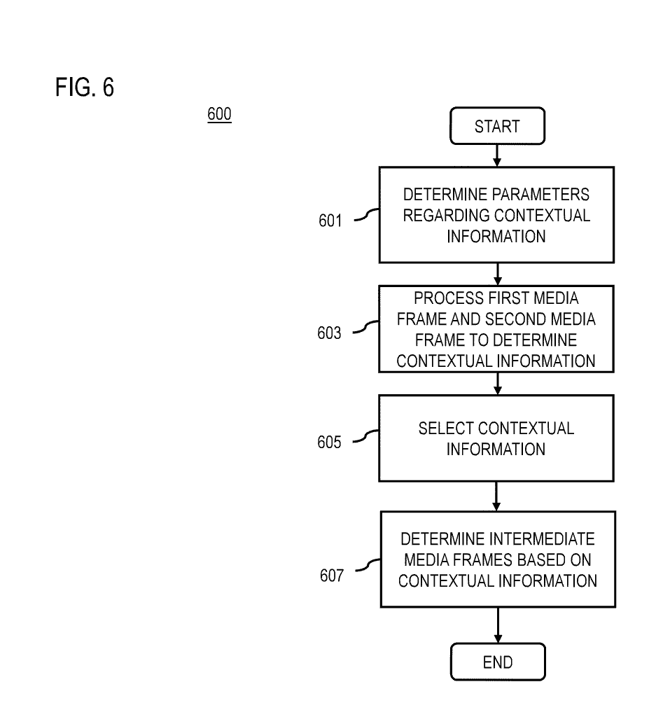

FIG. 6 is a flowchart of a process for determining contextual information, according to one embodiment. In one embodiment, the control logic 221 performs the process 600 and is implemented in, for instance, a chip set including a processor and a memory as shown in FIG. 10. In one embodiment, the control logic 221 may determine what comprises contextual information. For example, the control logic 221 may determine contextual information wherein the contextual information includes, at least in part, spatial information, temporal information, information regarding recognized objects, or a combination thereof. With step 603, the control logic 221 may process and/or facilitate a processing of the at least one first media frame, the at least one second media frame, or a combination thereof to determine contextual information. In one embodiment, such processing may be of frame contents (or objects within the frames) and/or of media associated with the frames. Then with step 605, the control logic 221 may determine, from the UEs 101 a selection of contextual information to note. For instance, users may specify objects or people that they wish to be in the intermediate frames. Based on such collective contextual information criteria, control logic 221 may determine the contextual information wherein the one or more intermediate media frames are further determine based, at least in part, on the contextual information.

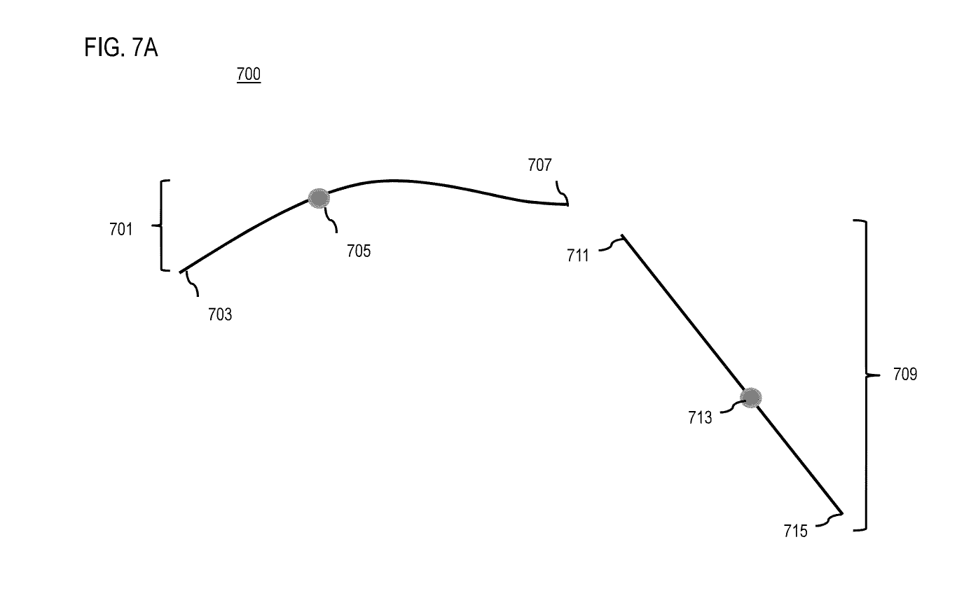

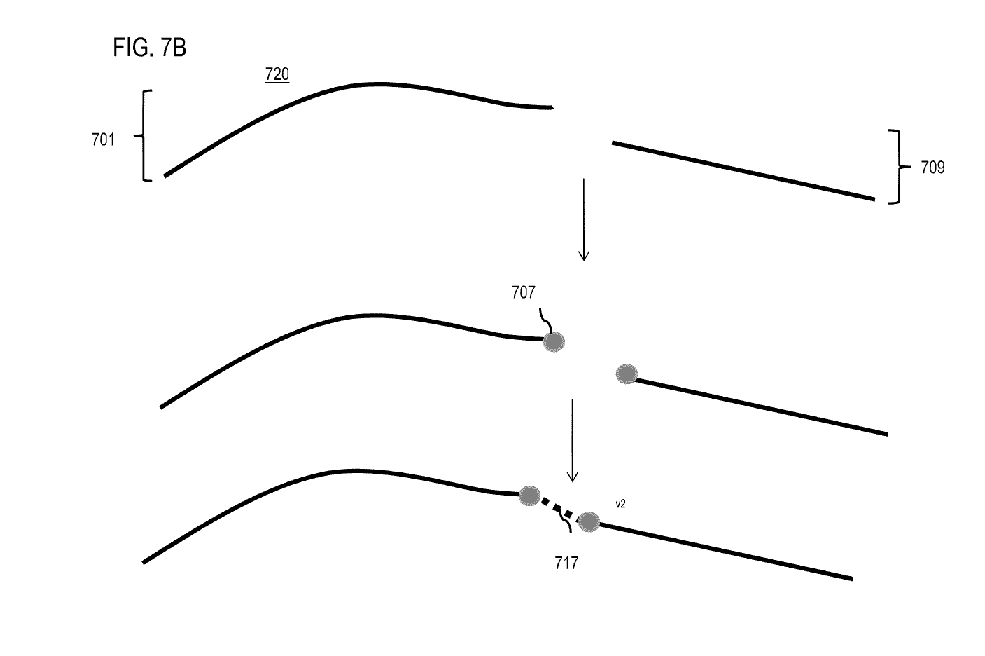

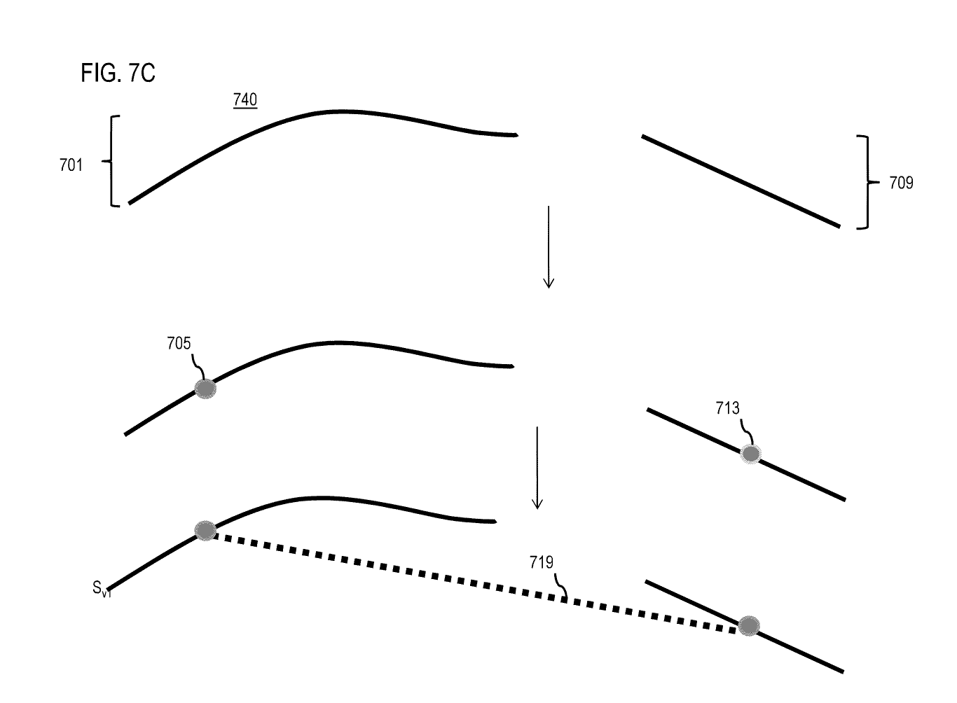

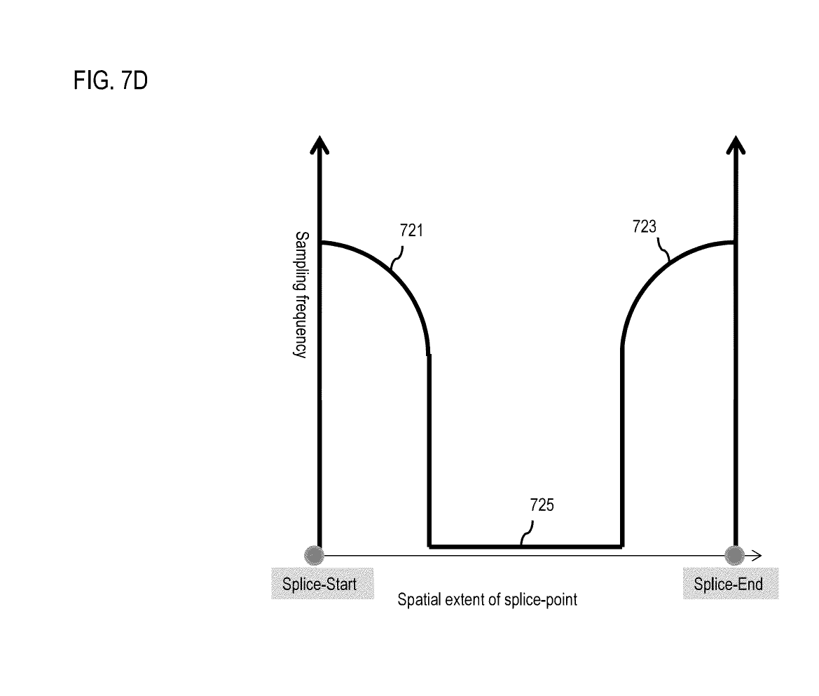

FIG. 7A is a diagram of a use case 700, in one embodiment. More specifically, use case 700 may represent a case for two video segments. In one embodiment, a first video segment 701 may have a starting point 703, an intermediate point 705, and an end point 707. A second video segment 709 may include starting point 711, intermediate point 713, and end point 715.

FIG. 7B is a diagram of a use case 720, in one embodiment, where the system 100 may calculate the position information for two media segments, where the first frame and second frame are at endpoints of the media segments. In one embodiment, the system 100 may calculate position information for end point 707 of the first video segment 701, as well as position information for starting point 711 of the second video segment 709. Then, the system 100 may calculate a desired trajectory connecting points 707 and 711. This trajectory may be trajectory 717. In one embodiment, the system 100 may select the trajectory based on application and/or user preferences. For example, the trajectory 717 may include the shortest path between two splice points, and/or a more circuitous path between the two splice points. In another embodiment, the trajectory 717 may take into account contextual information. For example, if the first video segment 701 and second video segment 709 indicate a pedestrian route, the trajectory 717 may trace the pedestrian route in a way that connects the two points 707 and 711. In other words, use case 720 may use pose trajectory information (including mode of transport information) and/or contextual information to determine the trajectory 717 that may represent the transition between points 707 and 711. The system 100 may use any suitable method to determine context (e.g., pedestrian route, bicycle, car, etc.).

FIG. 7C is a diagram of a use case 740, in one embodiment, where the system 100 may calculate the position information for two media segments, where the first frame and the second frame are at an intermediate position within the media segments. For instance, given a first video segment 701 with starting point 703, intermediate point 705, and end point 707, as well as a second video segment 709 with starting point 711, intermediate point 713, and end point 715, the system 100 may seek to splice together intermediate point 705 and intermediate point 713. To do this, the system 100 may determine a trajectory 719. In one case, such splicing may be to cut out bad quality. In one embodiment, video segment 701 and video segment 709 may be part of one video file or one larger video segment. In another embodiment, the two video segments may derive from different files. As previously discussed, the media segments in use cases 700, 720, and 740 are video segments only as one embodiment of system 100's operations. The same cases may be adapted to image, multimedia, and/or audio segments.

FIG. 7D is a diagram of a splice media sampling curve, in one embodiment. In one embodiment, the splice media sampling curve may represent the frequency at which media with appropriate pose information is retrieved and/or spliced together to create the transition between a first frame and a second frame. In one instance, the frequency of retrieval may refer to retrieval of images from a database of registered media, where the media is tagged or associated with pose information. In one embodiment, the number of images chosen for insertion for splicing depends on an application and/or user settings for the duration of the transition. For instance, a system 100 may maintain various sets of settings and/or frequency corresponding to various durations. For example, a transition that is 60 seconds long may have particular settings, while a transition that is two minutes long might have another group of settings. For instance settings may be based on artistic preferences, limitations in storage, and/or particular usages of applications.

In one embodiment, a splice media sampling curve may include different frequency at different timing intervals. For instance, close to the first and second frames (or the start and end points of the splice), sampling frequency might be higher. For instance, frequency 721 and frequency 723 are closer to the end points, and therefore have higher frequency. At an intermediate point between the two end points, sampling frequency 725 may be lower to accommodate a balance between a smooth transition and necessity. For instance, while 30 images spliced together may create a smooth transition, in a given time interval, the human eye may only see three of the images. The system 100 may then determine the frequency where sampling more than three images in a given time period would be unnecessary.

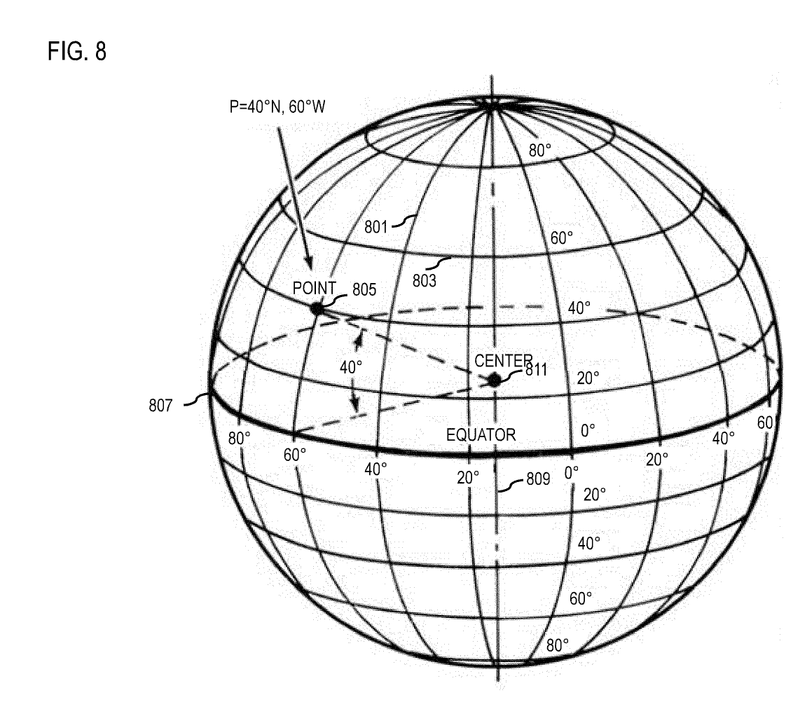

FIG. 8 is a diagram of elliptical model of the earth utilized in the process of FIGS. 3-6, according to one embodiment. The earth surface is often approximated by a spherical model as illustrated in FIG. 8. Latitude (801) and longitude (803) are geographic coordinates that respectively specify the north to south position and east to west position of a point on earth surface. Such two dimensional geographic coordinate system enables every location on earth to be specified by a pair of latitude (801) and longitude (803), for instance, diagram 807 presents an example of a point P (805) (N 40°, W 60°) in a 2D geographic coordinate system (GCS 2D). In one scenario, if the height (809) of a geographic location is of interest, a triple of latitude, longitude and altitude (or elevation) can be used to represent a location that resides below, on or above earth surface, for instance, N 40°, W 60°, H 100 meters, wherein the height is defined as the distance between the point in question and a reference geodetic datum. The choice of the actual reference datum is defined by the geodetic system under consideration. For instance, the commonly used World Geodetic system (WGS 84) uses an elliptical datum surface and Earth Gravitational Model 1996 (EGM 96) geo-id for this purpose.

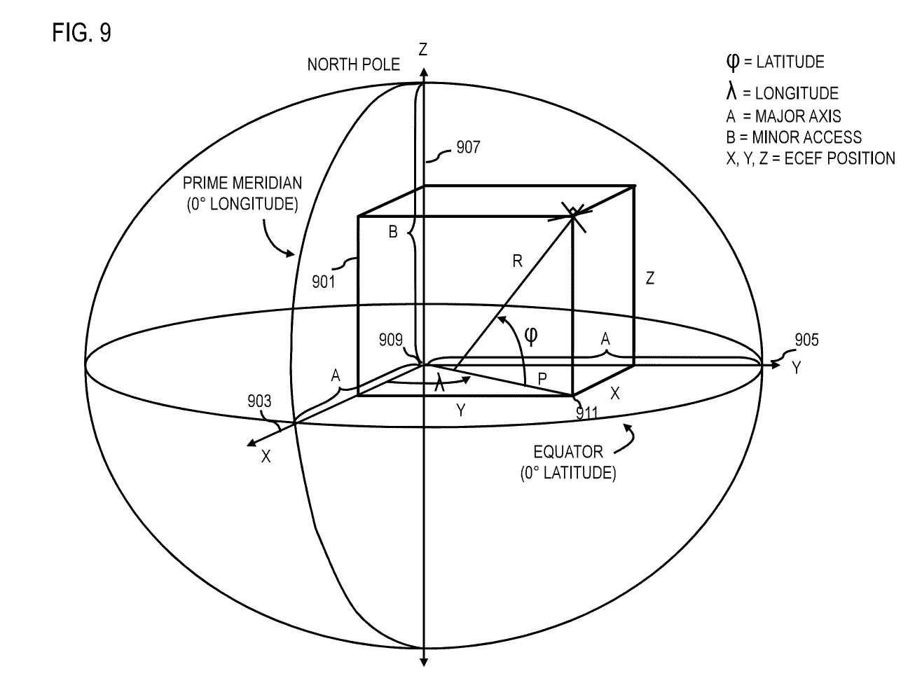

FIG. 9 is a diagram of an earth centered, earth fixed (ECEF) Cartesian coordinate system utilized in the process of FIGS. 3-6, according to one embodiment. A general Cartesian coordinate system for a three dimensional space (901) is uniquely defined by its origin point and three perpendicular axis lines (X (903), Y (905), Z (907)) meeting at the origin O (909). A 3D point P (911) is then specified by a triple of numerical coordinates (Xp, Yp, Zp), which are the signed distances from the point P to the three planes defined by two axes (Y-Z, X-Z, X-Y) respectively. In one scenario, the ECEF Cartesian coordinate system has its origin point (0,0,0) defined as the center of the mass of the earth, its X-axis intersects the sphere of the earth at 0° latitude (equator) and O° longitude and its Z-axis points towards the north pole, wherein a one to one mapping exists between ECEF and the geo-graphic co-ordination systems.

FIG. 10 illustrates a Cartesian coordinate system (CCS) 3D local system (1001) with its origin point restricted on earth and three axes (X (1003)-Y(1007)-Z(1005)) utilized in the process of FIGS. 3-6, according to one embodiment. A CCS_{—}3D_local system is a Cartesian coordinate system that has its origin point restricted on earth surface. FIG. 10 is a representation of a 3D earth modeling, wherein a CCS_{—}3D_local system is often used to represent a set of 3D geo-augmented data that are near to a reference point on earth, for instance, the 3D geo-augmented data may cover a limited space of 10 km, thereby making the co-ordinate system local. In one scenario, given the origin point and three axes of a CCS_{—}3D_local system, there exists a unique transformation between the CCS_{—}3D_ECEF and the local system in question. If the origin and three axes are unknown, it is difficult to map points in CCS_{—}3D_local to CCS_{—}3D_ECEF system.

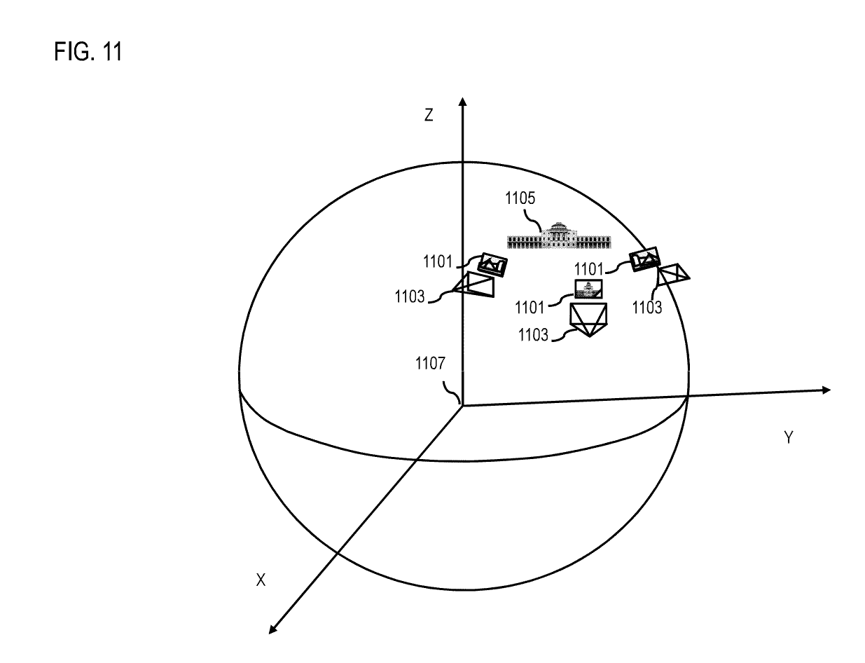

FIG. 11 is a diagram of a geo video data utilized in the process of FIGS. 3-6, according to one embodiment. In one embodiment, a complete geo video data, may consist of four items: 1) video frames (1101), 2) camera pose (1103), 3) a set of 3D points that are viewable from one or more multiple video frames (1105), and 4) an ECEF Cartesian coordinate system in which the three data items are defined (1107).

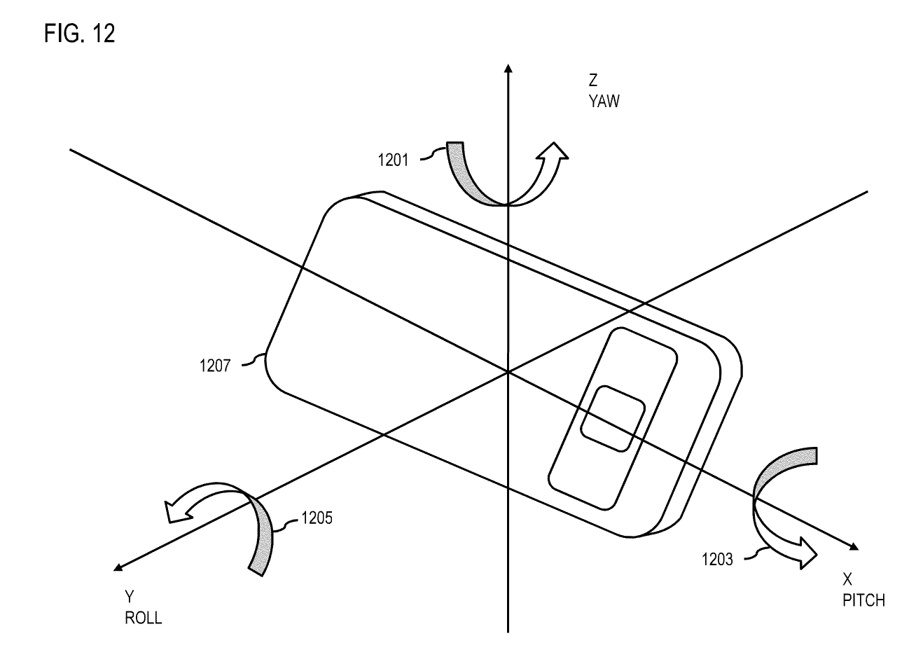

FIG. 12 is a diagram of a camera orientation in a 3D space utilized in the process of FIGS. 3-6, according to one embodiment. Here, Yaw (1201) is a counterclockwise rotation along the z axis, Pitch (1203) is a counterclockwise rotation along the x axis, and roll (1205) is a counterclockwise rotation along the y axis. In one scenario, the video frames are often regarded as a sequence of still images that are captured (or displayed) at different time at varying camera locations. In one scenario, the camera pose of associated videos frames represent 3D locations and orientations of the video-capturing-camera at the time when the video frames were recorded. The camera locations can be simply described as X_{L}, Y_{L}, Z_{L}. The orientation can be described as roll, yaw and pitch angles of rotating the camera from a reference placement to its current placement. Further, the orientation can be represented by rotation matrices or quaternions, which are mathematically equivalent to Euler angles. With the camera location and orientation, one can define the camera movement with six degrees of freedom (6 DoF) in a coordinate system.

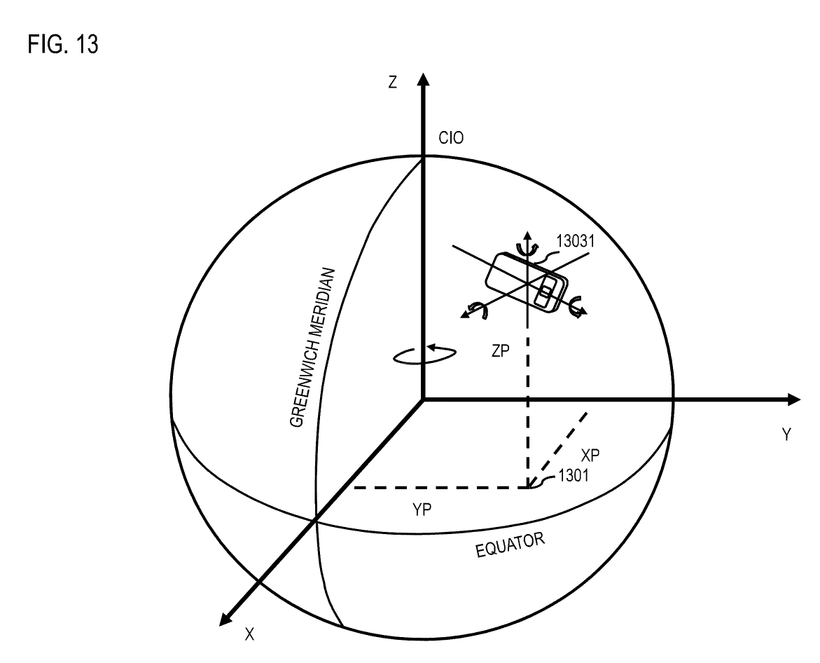

FIG. 13 illustrates an example of a camera pose in CCS_{—}3D_ECEF utilized in the process of FIGS. 3-6, according to one embodiment. In one scenario, a point cloud is a set of 3D points that are viewable from one or more multiple video frames, when viewed from a given camera pose (1301), 3D points are projected, according to proper camera models, onto the 2D image and gives rise to color intensities at different pixel locations (1303). In the context of Earth modeling, 3D point clouds can be directly measured by Light Detection and Ranging (LIDAR) technology. Alternatively, 3D point clouds can be reconstructed from input video frames by using computer vision Structure-From-Motion (SFM) technology. Within CCS_{—}3D_ECEF, 3D point clouds as well as camera poses needs to be accurately defined:

(1) When a CCS_{—}3D_ECEF is used, the camera poses and the point clouds are globally defined.
(2) If a CCS_{—}3D_Local system with known origin and axes is used, the camera poses and point clouds can be uniquely mapped to the CCS_{—}3D_ECEF. By doing this, the camera pose is also defined in a global coordinate system. Besides, if a CCS_{—}3D_Local system with unknown origin and axes is used, camera poses and point clouds can only be defined within the local coordinate system, because of the difficulty to map point-clouds and camera poses into CCS_{—}3D_ECEF.

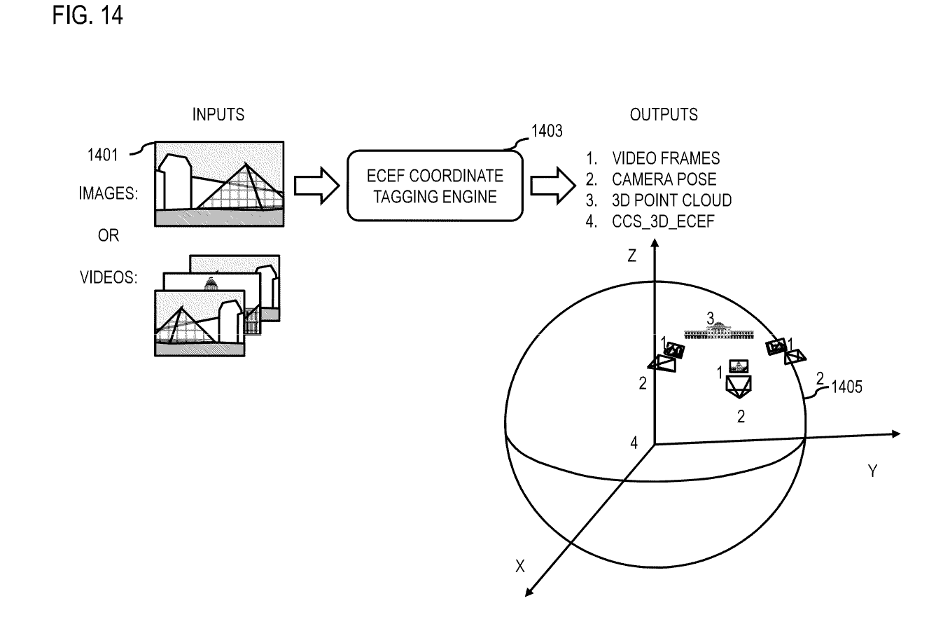

FIG. 14 is a diagram of user interface utilized in the process of FIGS. 3-6, according to various embodiments. FIG. 14 illustrates a general overview of the inputs and outputs of the ECEF coordinate tagging engine, wherein the engine extracts accurate geo-location metadata from input data. The input to the ECEF coordinate tagging engine can be either a collection of images or a sequence of video frames (1401). After processing, the engine outputs a set of geo-location metadata, including registered video frames, corresponding camera poses and reconstructed 3D point clouds (1403). All these data are defined within a CCS_{—}3D_Local system with known origin and axes (1405). Therefore, camera poses and point clouds can be uniquely mapped to the CCS_{—}3D_ECEF.

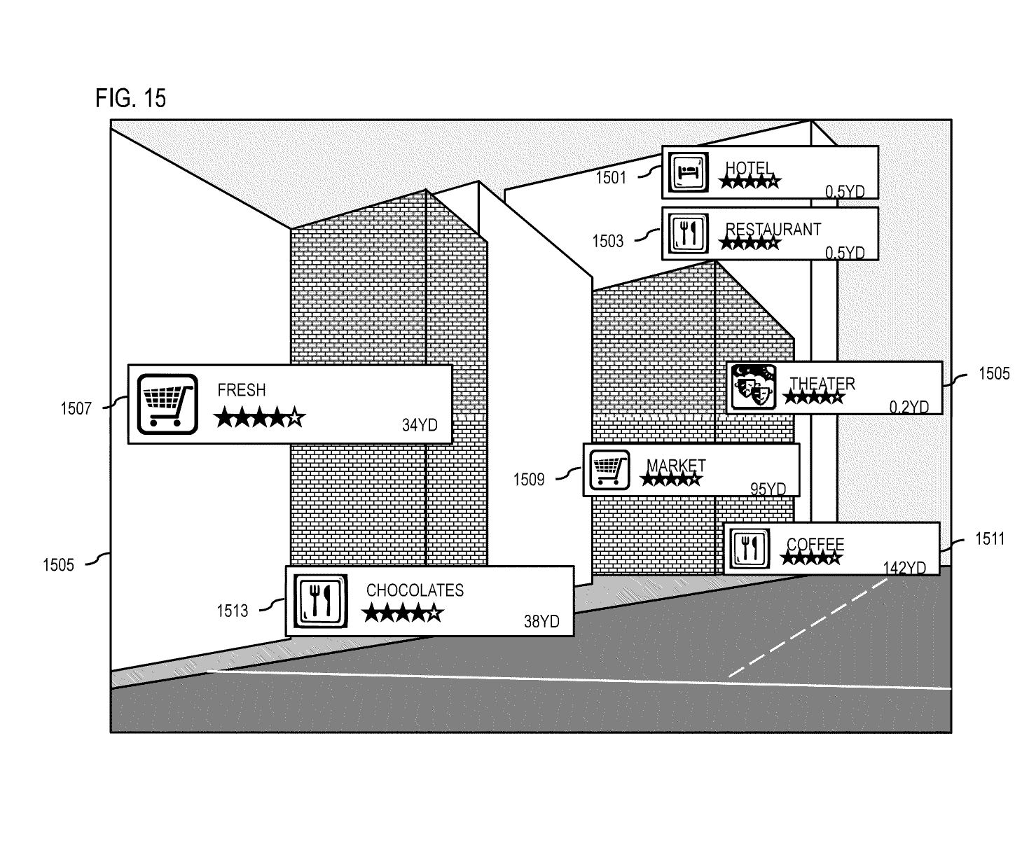

FIG. 15 is a diagram of user interface utilized in the process of FIGS. 3-6, according to various embodiments. FIG. 15 illustrates an example of the augmented video with POIs superimposed on video frames. In one scenario, based on POIs and associated geo metadata, it is possible to augment a geocoordinate-tagged video with nearby POIs data (1505). During the playback of a geocoordinate-tagged video, the change of camera poses gives rise to corresponding change in the rendered POI data, thus creating augmented-reality experience. The rendering of POIs may be associated with the playback of a recorded geocoordinate-tagged video, instead of the on-site camera viewfinder images. In one scenario, Peter visits XYZ shopping mall, and takes a video of the mall. Upon uploading the video, he would get a video with added POI information, for instance, the hotel (1501), the restaurant (1503), the theatre (1505), the market (1509) etc., within XYZ shopping mall, with reviews and distance information adhered to the display.

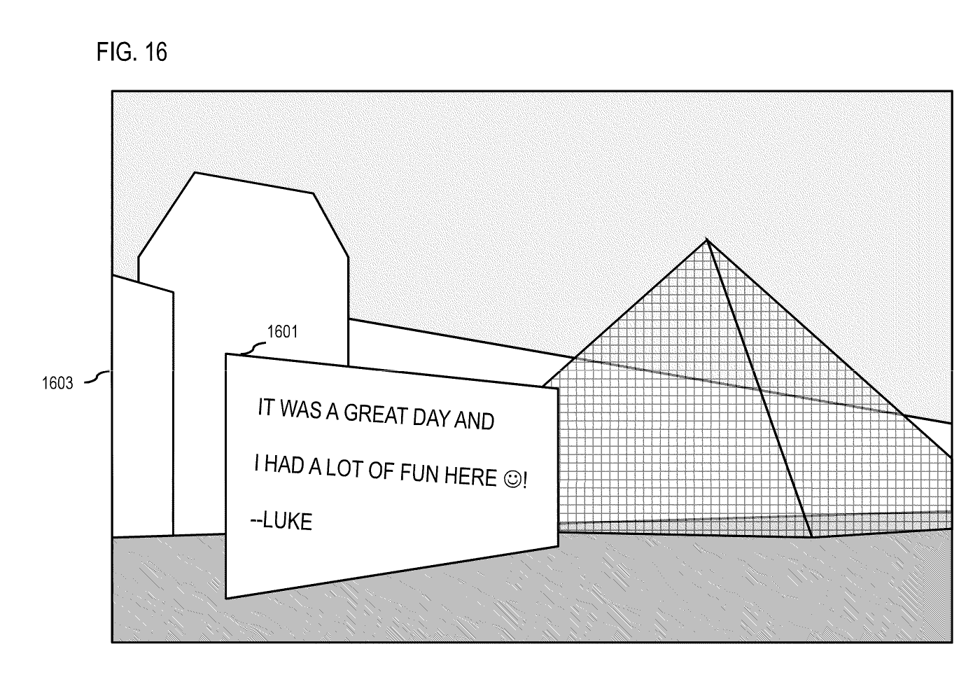

FIG. 16 is a diagram of user interface utilized in the process of FIGS. 3-6, according to various embodiments. FIG. 16 presents an example of a social virtual board in a video frame. In one scenario, social aspect of geocoordinate-tagged videos is a unique feature that allows sharing of a geocoordinate-tagged video (and POIs) among friends or people of interest. In one scenario, certain virtual objects, for instance, a virtual board, may be rendered accordingly during the playback of a geocoordinate-tagged video (1603). Such a virtual board can be used to leave comments among friends. In one scenario, Mike goes to Paris, visits a museum, and takes a video. After he uploads the video together with his comments of the trip, he would get a video with added virtual social board where his feeling of the trip is added (1601). If Mike shows the video to his friends, they can see Mike's comments about the trip and also leave their comments on the board. Further, the augmented video is rendered with the calculated camera pose for each image, instead of rough sensor data, resulting in more accurate rendering.

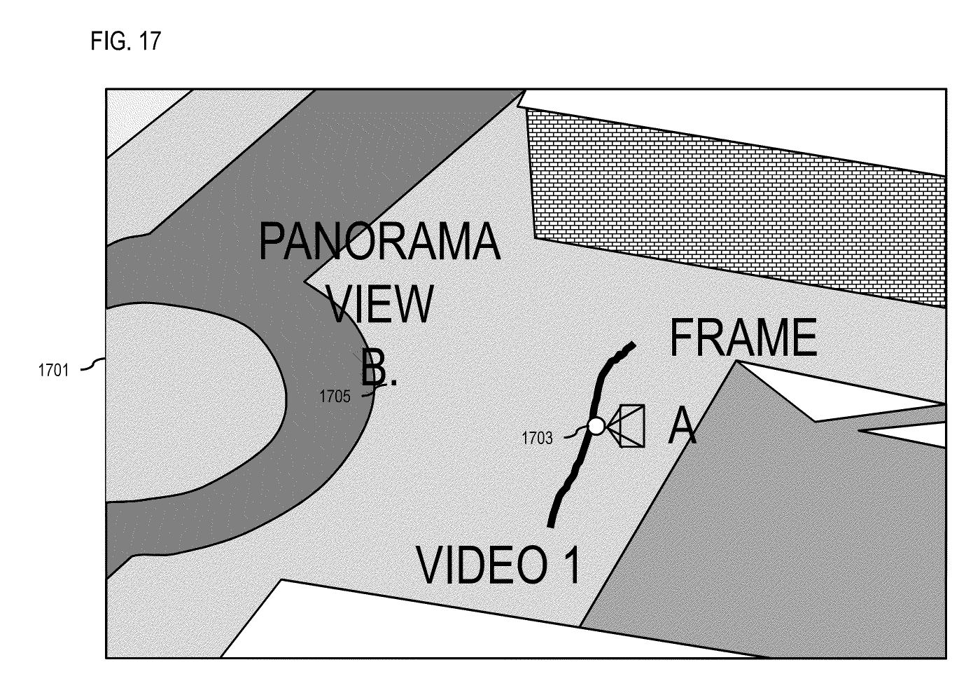

FIG. 17 is a diagram of user interface utilized in the process of FIGS. 3-6, according to various embodiments. FIG. 17 presents an example of switching from a video frame A to the panorama view B during the playback of the video 1. In one scenario, panorama images are often tagged with GPS information (i.e. latitude and longitude in GCS_{—}2D). Based on panorama image geo-location information, it is possible to augment geocoordinate-tagged video with nearby panorama images. During the playback of a geocoordinate-tagged video, the field of view (FOV) of every video frame can be extended to 360° by using nearby panorama images (1701). In one scenario, the FOV of frame A is limited to the entry of ABC museum (1703). Therefore, the viewers may interactively change the FOV to the opposite side by using panorama image taken at position B (1705).

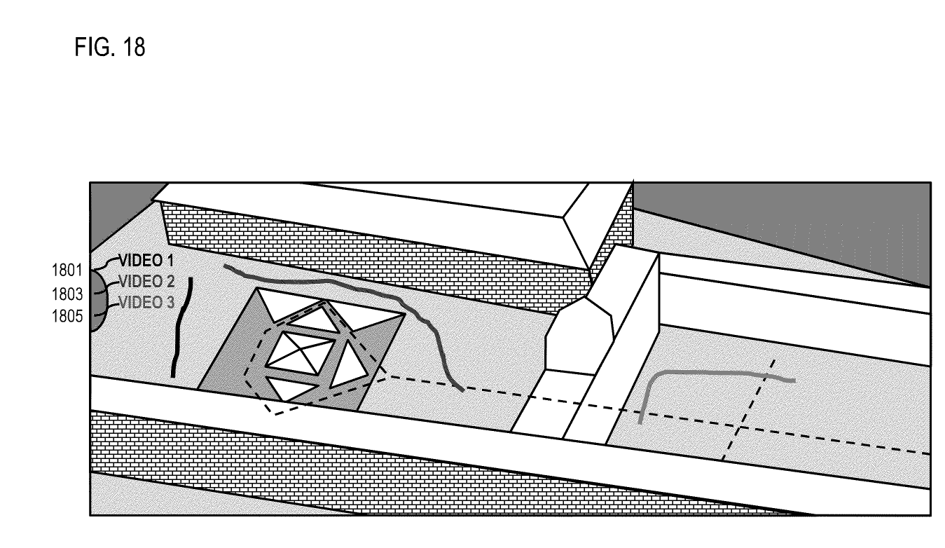

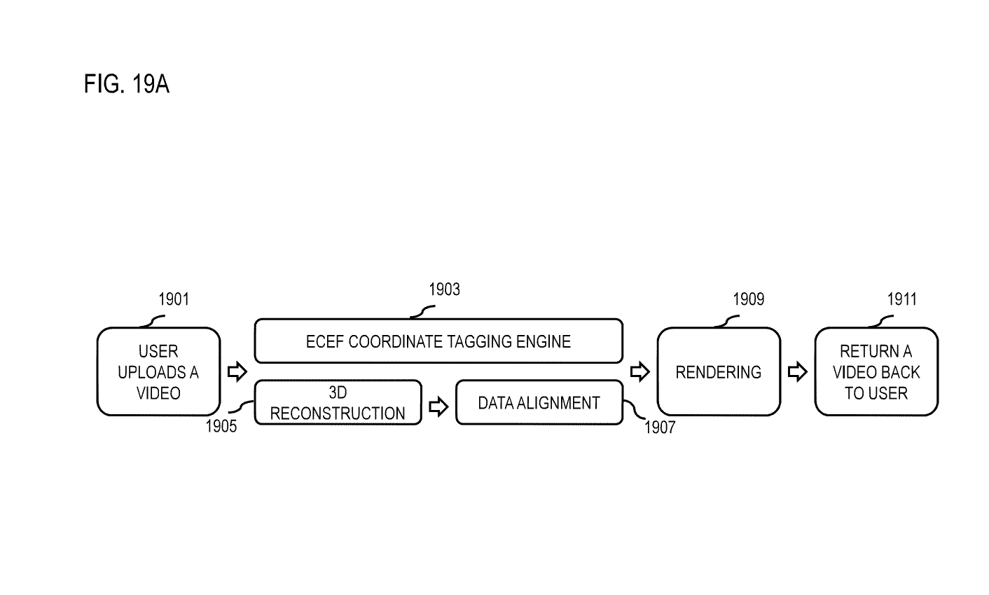

FIG. 18 is a diagram of user interface utilized in the process of FIGS. 3-6, according to various embodiments. FIG. 18 presents an illustration whereby three videos (1801, 1803, 1805) are taken by three different users at different time and locations of POI. Since all geocoordinate-tagged video data can be reconstructed within the CCS_{—}3D_ECEF system, it is possible to integrate nearby geocoordinate-tagged videos that are shot at different locations, time and by different people. During the playback of a geocoordinate-tagged video, the viewer may choose to switch from the current geocoordinate-tagged video to a nearby geocoordinate-tagged video. Both the path and the angle of the viewing camera can be interactively controlled by the viewer. In one scenario, there may be three videos with different capturing-camera-paths around ABC museum. During the playback of the “video 2” (1803), the user may choose to view frames from “video 1” (1801) or “video 3” (1805).

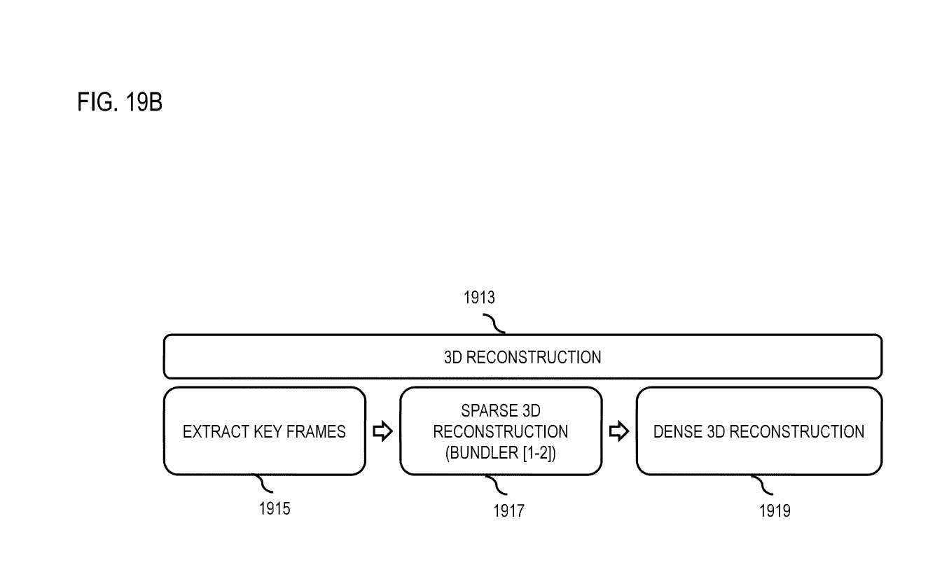

FIG. 19A is a diagram of user interface utilized in the process of FIGS. 3-6, according to various embodiments. FIG. 19A shows the pipeline of processing of images to determine camera location information and/or camera pose information associated with at least one camera capturing the one or more images. In one scenario, a user takes a video with his UE 101, the video is automatically uploaded to the ECEF coordinate tagging engine (1901), and then the ECEF coordinate tagging engine generates the geocoordinate-tagged video data (1903). Then, the video is rendered and returned to the user (1909 and 1911).

FIG. 19B is a diagram of user interface utilized in the process of FIGS. 3-6, according to various embodiments. FIG. 19B presents the three steps in the 3D reconstruction (1913). The invented ECEF coordinate tagging engine involves two important data-processing components, namely, 3D reconstruction (1905) and data alignment (1907). In one scenario, once a video clip is uploaded, ECEF coordinate tagging engine extracts the key frames (1915), reconstructs the scene as the 3D point cloud (1917) and recovers camera poses within a CCS_{—}3D_Local system (1919).

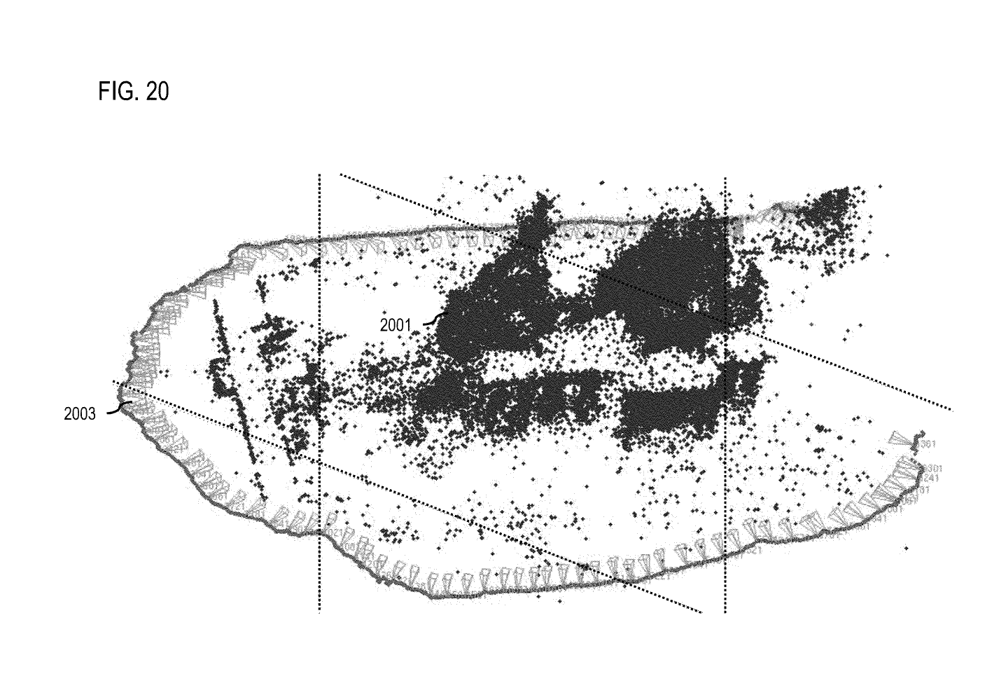

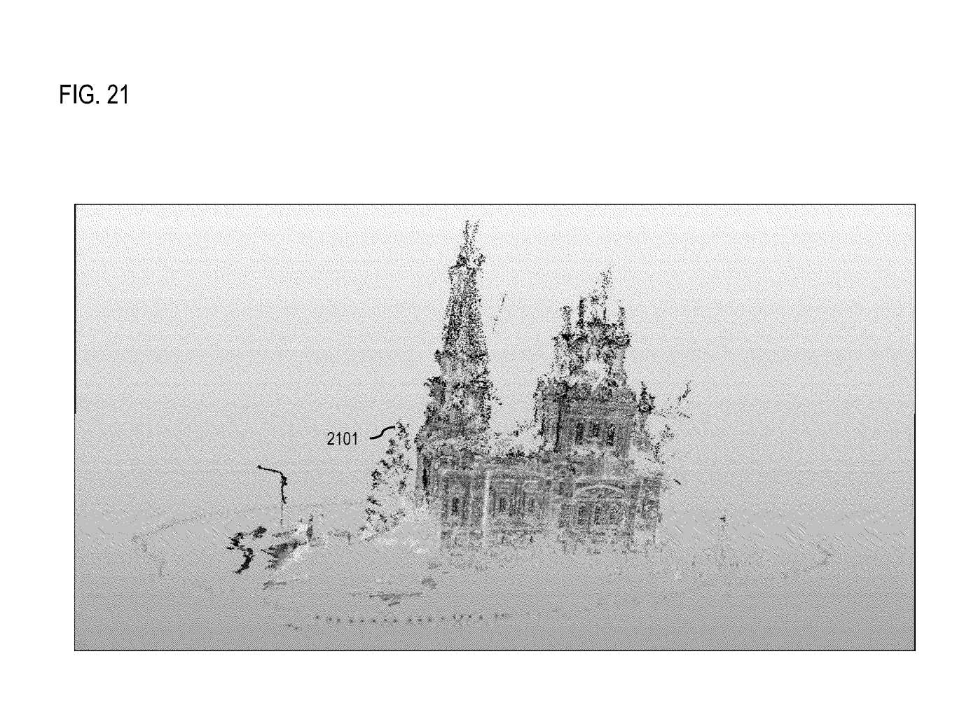

FIG. 20 is a diagram of user interface utilized in the process of FIGS. 3-6, according to various embodiments. FIGS. 20 and 21 are examples of reconstruction results, which consist of 3D point clouds for a location destination, for instance, ABC museum, and corresponding camera poses for each video frames. In one scenario, FIG. 20 presents an example of the reconstructed 3D point cloud (2001) for ABC museum and the corresponding local camera poses (2003). In one scenario, to better visualize the camera poses, camera poses of every 60 frames may be plotted.

FIG. 21 is a diagram of user interface utilized in the process of FIGS. 3-6, according to various embodiments. FIG. 21 shows the same reconstructed 3D point cloud as those in FIG. 20, but the point cloud is shown with additional attributes, such as, color information whereby the centers of cameras may be denoted with colors (2101) for user convenience.

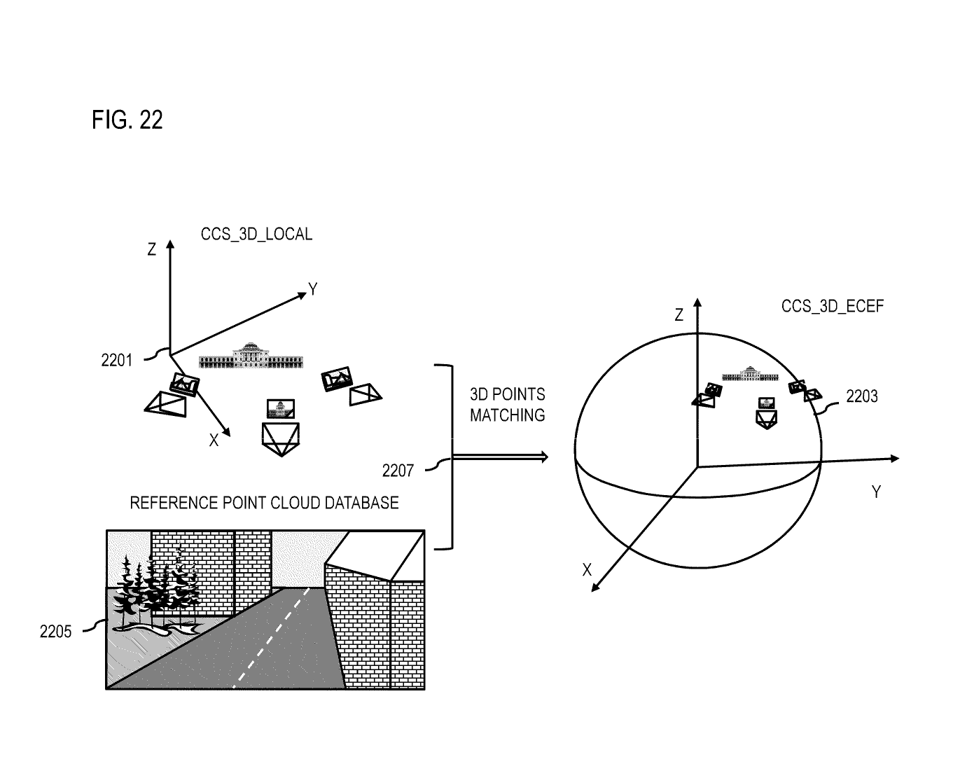

FIG. 22 is a diagram of user interface utilized in the process of FIGS. 3-6, according to various embodiments. FIG. 22 presents an example that is capable of establishing correspondence between CCS_{—}3D_Local system (2201) and the CCS_{—}3D_ECEF system (2203) with the help of reference point cloud data (e.g., the NAVTEQ True data) (2205) and point cloud matching technique (2207), and then represent the geocoordinate-tagged video data in CCS_{—}3D_ECEF system. Since reconstructed point clouds from the previous step are only defined within a CCS_{—}3D_Local system, this processing step establishes correspondences between the CCS_{—}3D_Local system and the CCS_{—}3D_ECEF system. In one scenario, the system can firstly use GPS data to roughly locate the area of the 3D point cloud, then take advantage of reference point cloud databases (e.g., NAVTEQ True Data) and adopt 3D point cloud matching techniques to find the exact correspondences between CCS_{—}3D_Local system and the CCS_{—}3D_ECEF system. By doing so, all the camera poses and 3D point cloud can be defined in CCS_{—}3D_ECEF system. In one scenario, the splicing platform 113 may mark point cloud data for augmenting the NAVTEQ database, if it cannot match the point cloud data to the NAVTEQ database.

The processes described herein for splicing video segments based on media capture device pose information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

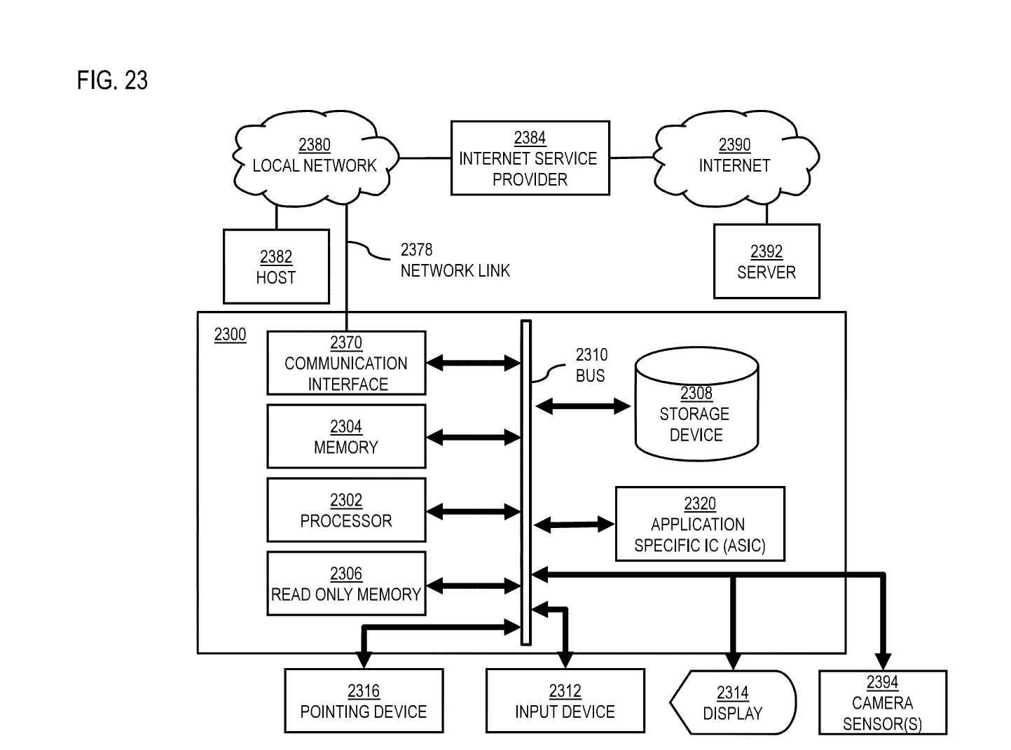

FIG. 23 illustrates a computer system 2300 upon which an embodiment of the invention may be implemented. Although computer system 2300 is depicted with respect to a particular device or equipment, it is contemplated that other devices or equipment (e.g., network elements, servers, etc.) within FIG. 23 can deploy the illustrated hardware and components of system 2300. Computer system 2300 is programmed (e.g., via computer program code or instructions) to splice video segments based on media capture device pose information as described herein and includes a communication mechanism such as a bus 2310 for passing information between other internal and external components of the computer system 2300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 2300, or a portion thereof, constitutes a means for performing one or more steps of splicing video segments based on media capture device pose information.

A bus 2310 includes one or more parallel conductors of information so that information is transferred quickly among devices coupled to the bus 2310. One or more processors 2302 for processing information are coupled with the bus 2310.

A processor (or multiple processors) 2302 performs a set of operations on information as specified by computer program code related to splice video segments based on media capture device pose information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 2310 and placing information on the bus 2310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 2302, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 2300 also includes a memory 2304 coupled to bus 2310. The memory 2304, such as a random access memory (RAM) or any other dynamic storage device, stores information including processor instructions for splicing video segments based on media capture device pose information. Dynamic memory allows information stored therein to be changed by the computer system 2300. RAM allows a unit of information stored at a location called a memory address to be stored and retrieved independently of information at neighboring addresses. The memory 2304 is also used by the processor 2302 to store temporary values during execution of processor instructions. The computer system 2300 also includes a read only memory (ROM) 2306 or any other static storage device coupled to the bus 2310 for storing static information, including instructions, that is not changed by the computer system 2300. Some memory is composed of volatile storage that loses the information stored thereon when power is lost. Also coupled to bus 2310 is a non-volatile (persistent) storage device 2308, such as a magnetic disk, optical disk or flash card, for storing information, including instructions, that persists even when the computer system 2300 is turned off or otherwise loses power.

Information, including instructions for splicing video segments based on media capture device pose information, is provided to the bus 2310 for use by the processor from an external input device 2312, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 2300. Other external devices coupled to bus 2310, used primarily for interacting with humans, include a display device 2314, such as a cathode ray tube (CRT), a liquid crystal display (LCD), a light emitting diode (LED) display, an organic LED (OLED) display, a plasma screen, or a printer for presenting text or images, and a pointing device 2316, such as a mouse, a trackball, cursor direction keys, or a motion sensor, for controlling a position of a small cursor image presented on the display 2314 and issuing commands associated with graphical elements presented on the display 2314, and one or more camera sensors 2394 for capturing, recording and causing to store one or more still and/or moving images (e.g., videos, movies, etc.) which also may comprise audio recordings. In some embodiments, for example, in embodiments in which the computer system 2300 performs all functions automatically without human input, one or more of external input device 2312, display device 2314 and pointing device 2316 may be omitted.

In the illustrated embodiment, special purpose hardware, such as an application specific integrated circuit (ASIC) 2320, is coupled to bus 2310. The special purpose hardware is configured to perform operations not performed by processor 2302 quickly enough for special purposes. Examples of ASICs include graphics accelerator cards for generating images for display 2314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 2300 also includes one or more instances of a communications interface 2370 coupled to bus 2310. Communication interface 2370 provides a one-way or two-way communication coupling to a variety of external devices that operate with their own processors, such as printers, scanners and external disks. In general the coupling is with a network link 2378 that is connected to a local network 2380 to which a variety of external devices with their own processors are connected. For example, communication interface 2370 may be a parallel port or a serial port or a universal serial bus (USB) port on a personal computer. In some embodiments, communications interface 2370 is an integrated services digital network (ISDN) card or a digital subscriber line (DSL) card or a telephone modem that provides an information communication connection to a corresponding type of telephone line. In some embodiments, a communication interface 2370 is a cable modem that converts signals on bus 2310 into signals for a communication connection over a coaxial cable or into optical signals for a communication connection over a fiber optic cable. As another example, communications interface 2370 may be a local area network (LAN) card to provide a data communication connection to a compatible LAN, such as Ethernet. Wireless links may also be implemented. For wireless links, the communications interface 2370 sends or receives or both sends and receives electrical, acoustic or electromagnetic signals, including infrared and optical signals, that carry information streams, such as digital data. For example, in wireless handheld devices, such as mobile telephones like cell phones, the communications interface 2370 includes a radio band electromagnetic transmitter and receiver called a radio transceiver. In certain embodiments, the communications interface 2370 enables connection to the communication network 105 for splicing video segments based on media capture device pose information to the UE 101.

The term “computer-readable medium” as used herein refers to any medium that participates in providing information to processor 2302, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 2308. Volatile media include, for example, dynamic memory 2304. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 2320.

Network link 2378 typically provides information communication using transmission media through one or more networks to other devices that use or process the information. For example, network link 2378 may provide a connection through local network 2380 to a host computer 2382 or to equipment 2384 operated by an Internet Service Provider (ISP). ISP equipment 2384 in turn provides data communication services through the public, world-wide packet-switching communication network of networks now commonly referred to as the Internet 2390.

A computer called a server host 2392 connected to the Internet hosts a process that provides a service in response to information received over the Internet. For example, server host 2392 hosts a process that provides information representing video data for presentation at display 2314. It is contemplated that the components of system 2300 can be deployed in various configurations within other computer systems, e.g., host 2382 and server 2392.

At least some embodiments of the invention are related to the use of computer system 2300 for implementing some or all of the techniques described herein. According to one embodiment of the invention, those techniques are performed by computer system 2300 in response to processor 2302 executing one or more sequences of one or more processor instructions contained in memory 2304. Such instructions, also called computer instructions, software and program code, may be read into memory 2304 from another computer-readable medium such as storage device 2308 or network link 2378. Execution of the sequences of instructions contained in memory 2304 causes processor 2302 to perform one or more of the method steps described herein. In alternative embodiments, hardware, such as ASIC 2320, may be used in place of or in combination with software to implement the invention. Thus, embodiments of the invention are not limited to any specific combination of hardware and software, unless otherwise explicitly stated herein.

The signals transmitted over network link 2378 and other networks through communications interface 2370, carry information to and from computer system 2300. Computer system 2300 can send and receive information, including program code, through the networks 2380, 2390 among others, through network link 2378 and communications interface 2370. In an example using the Internet 2390, a server host 2392 transmits program code for a particular application, requested by a message sent from computer 2300, through Internet 2390, ISP equipment 2384, local network 2380 and communications interface 2370. The received code may be executed by processor 2302 as it is received, or may be stored in memory 2304 or in storage device 2308 or any other non-volatile storage for later execution, or both. In this manner, computer system 2300 may obtain application program code in the form of signals on a carrier wave.

Various forms of computer readable media may be involved in carrying one or more sequence of instructions or data or both to processor 2302 for execution. For example, instructions and data may initially be carried on a magnetic disk of a remote computer such as host 2382. The remote computer loads the instructions and data into its dynamic memory and sends the instructions and data over a telephone line using a modem. A modem local to the computer system 2300 receives the instructions and data on a telephone line and uses an infra-red transmitter to convert the instructions and data to a signal on an infra-red carrier wave serving as the network link 2378. An infrared detector serving as communications interface 2370 receives the instructions and data carried in the infrared signal and places information representing the instructions and data onto bus 2310. Bus 2310 carries the information to memory 2304 from which processor 2302 retrieves and executes the instructions using some of the data sent with the instructions. The instructions and data received in memory 2304 may optionally be stored on storage device 2308, either before or after execution by the processor 2302.

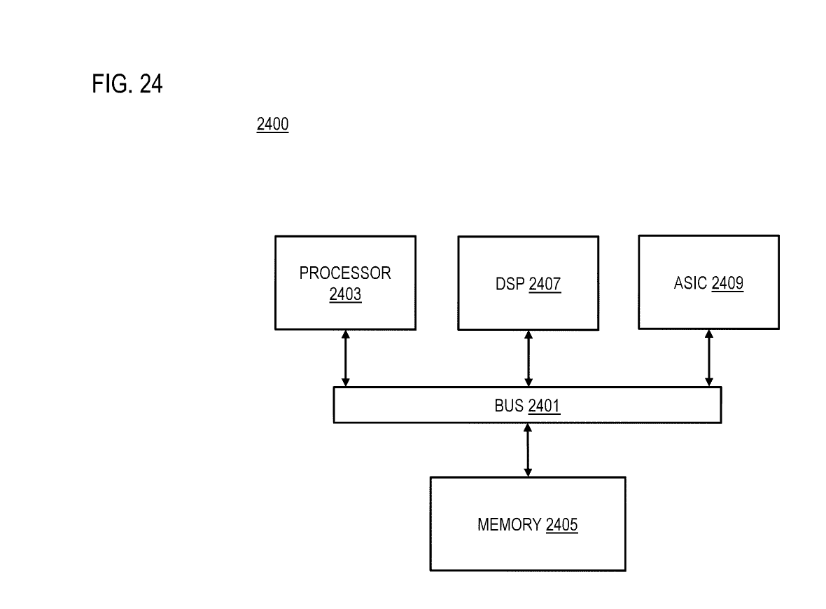

FIG. 24 illustrates a chip set or chip 2400 upon which an embodiment of the invention may be implemented. Chip set 2400 is programmed to splice video segments based on media capture device pose information as described herein and includes, for instance, the processor and memory components described with respect to FIG. 23 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 2400 can be implemented in a single chip. It is further contemplated that in certain embodiments the chip set or chip 2400 can be implemented as a single “system on a chip.” It is further contemplated that in certain embodiments a separate ASIC would not be used, for example, and that all relevant functions as disclosed herein would be performed by a processor or processors. Chip set or chip 2400, or a portion thereof, constitutes a means for performing one or more steps of providing user interface navigation information associated with the availability of functions. Chip set or chip 2400, or a portion thereof, constitutes a means for performing one or more steps of splicing video segments based on media capture device pose information.

In one embodiment, the chip set or chip 2400 includes a communication mechanism such as a bus 2401 for passing information among the components of the chip set 2400. A processor 2403 has connectivity to the bus 2401 to execute instructions and process information stored in, for example, a memory 2405. The processor 2403 may include one or more processing cores with each core configured to perform independently. A multi-core processor enables multiprocessing within a single physical package. Examples of a multi-core processor include two, four, eight, or greater numbers of processing cores. Alternatively or in addition, the processor 2403 may include one or more microprocessors configured in tandem via the bus 2401 to enable independent execution of instructions, pipelining, and multithreading. The processor 2403 may also be accompanied with one or more specialized components to perform certain processing functions and tasks such as one or more digital signal processors (DSP) 2407, or one or more application-specific integrated circuits (ASIC) 2409. A DSP 2407 typically is configured to process real-world signals (e.g., sound) in real time independently of the processor 2403. Similarly, an ASIC 2409 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 2400 includes merely one or more processors and some software and/or firmware supporting and/or relating to and/or for the one or more processors.

The processor 2403 and accompanying components have connectivity to the memory 2405 via the bus 2401. The memory 2405 includes both dynamic memory (e.g., RAM, magnetic disk, writable optical disk, etc.) and static memory (e.g., ROM, CD-ROM, etc.) for storing executable instructions that when executed perform the inventive steps described herein to splice video segments based on media capture device pose information. The memory 2405 also stores the data associated with or generated by the execution of the inventive steps.

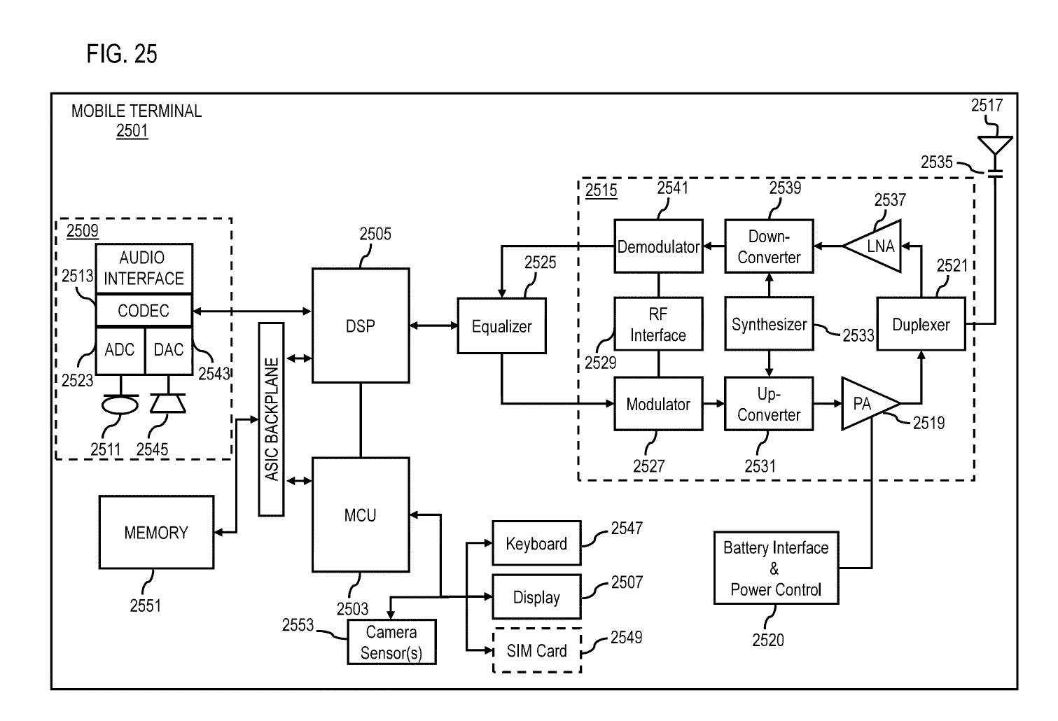

FIG. 25 is a diagram of exemplary components of a mobile terminal (e.g., handset) for communications, which is capable of operating in the system of FIG. 1, according to one embodiment. In some embodiments, mobile terminal 2501, or a portion thereof, constitutes a means for performing one or more steps of splicing video segments based on media capture device pose information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 2503, a Digital Signal Processor (DSP) 2505, and a receiver/transmitter unit including a microphone gain control unit and a speaker gain control unit. A main display unit 2507 provides a display to the user in support of various applications and mobile terminal functions that perform or support the steps of splicing video segments based on media capture device pose information. The display 2507 includes display circuitry configured to display at least a portion of a user interface of the mobile terminal (e.g., mobile telephone). Additionally, the display 2507 and display circuitry are configured to facilitate user control of at least some functions of the mobile terminal. An audio function circuitry 2509 includes a microphone 2511 and microphone amplifier that amplifies the speech signal output from the microphone 2511. The amplified speech signal output from the microphone 2511 is fed to a coder/decoder (CODEC) 2513.

A radio section 2515 amplifies power and converts frequency in order to communicate with a base station, which is included in a mobile communication system, via antenna 2517. The power amplifier (PA) 2519 and the transmitter/modulation circuitry are operationally responsive to the MCU 2503, with an output from the PA 2519 coupled to the duplexer 2521 or circulator or antenna switch, as known in the art. The PA 2519 also couples to a battery interface and power control unit 2520.

In use, a user of mobile terminal 2501 speaks into the microphone 2511 and his or her voice along with any detected background noise is converted into an analog voltage. The analog voltage is then converted into a digital signal through the Analog to Digital Converter (ADC) 2523. The control unit 2503 routes the digital signal into the DSP 2505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 2525 for compensation of any frequency-dependent impairments that occur during transmission though the air such as phase and amplitude distortion. After equalizing the bit stream, the modulator 2527 combines the signal with a RF signal generated in the RF interface 2529. The modulator 2527 generates a sine wave by way of frequency or phase modulation. In order to prepare the signal for transmission, an up-converter 2531 combines the sine wave output from the modulator 2527 with another sine wave generated by a synthesizer 2533 to achieve the desired frequency of transmission. The signal is then sent through a PA 2519 to increase the signal to an appropriate power level. In practical systems, the PA 2519 acts as a variable gain amplifier whose gain is controlled by the DSP 2505 from information received from a network base station. The signal is then filtered within the duplexer 2521 and optionally sent to an antenna coupler 2535 to match impedances to provide maximum power transfer. Finally, the signal is transmitted via antenna 2517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 2501 are received via antenna 2517 and immediately amplified by a low noise amplifier (LNA) 2537. A down-converter 2539 lowers the carrier frequency while the demodulator 2541 strips away the RF leaving only a digital bit stream. The signal then goes through the equalizer 2525 and is processed by the DSP 2505. A Digital to Analog Converter (DAC) 2543 converts the signal and the resulting output is transmitted to the user through the speaker 2545, all under control of a Main Control Unit (MCU) 2503 which can be implemented as a Central Processing Unit (CPU).

The MCU 2503 receives various signals including input signals from the keyboard 2547. The keyboard 2547 and/or the MCU 2503 in combination with other user input components (e.g., the microphone 2511) comprise a user interface circuitry for managing user input. The MCU 2503 runs a user interface software to facilitate user control of at least some functions of the mobile terminal 2501 to splice video segments based on media capture device pose information. The MCU 2503 also delivers a display command and a switch command to the display 2507 and to the speech output switching controller, respectively. Further, the MCU 2503 exchanges information with the DSP 2505 and can access an optionally incorporated SIM card 2549 and a memory 2551. In addition, the MCU 2503 executes various control functions required of the terminal. The DSP 2505 may, depending upon the implementation, perform any of a variety of conventional digital processing functions on the voice signals. Additionally, DSP 2505 determines the background noise level of the local environment from the signals detected by microphone 2511 and sets the gain of microphone 2511 to a level selected to compensate for the natural tendency of the user of the mobile terminal 2501.

The CODEC 2513 includes the ADC 2523 and DAC 2543. The memory 2551 stores various data including call incoming tone data and is capable of storing other data including music data received via, e.g., the global Internet. The software module could reside in RAM memory, flash memory, registers, or any other form of writable storage medium known in the art. The memory device 2551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 2549 carries, for instance, important information, such as the cellular phone number, the carrier supplying service, subscription details, and security information. The SIM card 2549 serves primarily to identify the mobile terminal 2501 on a radio network. The card 2549 also contains a memory for storing a personal telephone number registry, text messages, and user specific mobile terminal settings.

Further, one or more camera sensors 2553 may be incorporated onto the mobile station 2501 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of at least one first media frame and at least one second media frame;
at least one determination of pose information for at least one media capture device that captured the at least one first media frame, the at least one second media frame, or a combination thereof and
a processing of the pose information to determine one or more intermediate media frames for insertion between the at least one first media frame and the at least one second media frame.

2. A method of claim 1, wherein the (1) data and/or (2) information and/or (3) at least one signal are further based, at least in part, on the following:
at least one determination of pose trajectory information for at least one first media sequence associated with the at least one first media frame, at least one second media sequence associated with the at least one second media frame, or a combination thereof,
wherein the pose trajectory information represents at least one sequence of one or more media capture device poses estimated over the at least one media sequence, the at least one second media sequence, or a combination thereof; and
wherein the one or more intermediate media frames are further determined based, at least in part, on the pose trajectory information.

3. A method of claim 2, wherein the (1) data and/or (2) information and/or (3) at least one signal are further based, at least in part, on the following:
at least one determination of at least one frequency for calculating the one or more media capture device poses based, at least in part, on one or more relative positions of (a) the at least one first media frame within the at least one first media sequence, (b) the at least one second media frame within the at least one second media sequence, or (c) a combination thereof.

4. A method of claim 2, wherein the (1) data and/or (2) information and/or (3) at least one signal are further based, at least in part, on the following:
at least one determination of a mode of transport information associated with the pose trajectory information, the pose information, or a combination thereof,
wherein the one or more intermediate media frames are further determined based, at least in part, on the mode of transport information.

5. A method of claim 1, wherein the (1) data and/or (2) information and/or (3) at least one signal are further based, at least in part, on the following:
at least one determination of the one or more intermediate media frames from at least one database of registered media.

6. A method of claim 1, wherein the (1) data and/or (2) information and/or (3) at least one signal are further based, at least in part, on the following:
a synthesizing of the one or more intermediate media frames based, at least in part, on the pose information.

7. A method of claim 1, wherein the (1) data and/or (2) information and/or (3) at least one signal are further based, at least in part, on the following:
a processing of the at least one first media frame, the at least one second media frame, or a combination thereof to determine contextual information,
wherein the one or more intermediate media frames are further determined based, at least in part, on the contextual information.

8. A method of claim 7, wherein the contextual information includes, at least in part, spatial information, temporal information, information regarding recognized objects, or a combination thereof.

9. A method of claim 1, wherein the at least one first media frame, the at least one second media frame, or a combination thereof includes, at least in part, one or more video frames, one or more audio frames, or a combination thereof.

10. A method of claim 1, wherein the at least one first media frame, the at least one second media frame, or a combination thereof is an end media frame, a start media frame, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine at least one first media frame and at least one second media frame;
determine pose information for at least one media capture device that captured the at least one first media frame, the at least one second media frame, or a combination thereof; and
process and/or facilitate a processing of the pose information to determine one or more intermediate media frames for insertion between the at least one first media frame and the at least one second media frame.

12. An apparatus of claim 11, wherein the apparatus is further caused to:
determine pose trajectory information for at least one first media sequence associated with the at least one first media frame, at least one second media sequence associated with the at least one second media frame, or a combination thereof,
wherein the pose trajectory information represents at least one sequence of one or more media capture device poses estimated over the at least one media sequence, the at least one second media sequence, or a combination thereof; and
wherein the one or more intermediate media frames are further determined based, at least in part, on the pose trajectory information.

13. An apparatus of claim 12, wherein the apparatus is further caused to:
determine at least one frequency for calculating the one or more media capture device poses based, at least in part, on one or more relative positions of (a) the at least one first media frame within the at least one first media sequence, (b) the at least one second media frame within the at least one second media sequence, or (c) a combination thereof.

14. An apparatus of claim 12, wherein the apparatus is further caused to:
determine mode of transport information associated with the pose trajectory information, the pose information, or a combination thereof,
wherein the one or more intermediate media frames are further determined based, at least in part, on the mode of transport information.

15. An apparatus of claim 11, wherein the apparatus is further caused to:
determine the one or more intermediate media frames from at least one database of registered media.

16. An apparatus of claim 11, wherein the apparatus is further caused to:
cause, at least in part, a synthesizing of the one or more intermediate media frames based, at least in part, on the pose information.

17. An apparatus of claim 11, wherein the apparatus is further caused to:
process and/or facilitate a processing of the at least one first media frame, the at least one second media frame, or a combination thereof to determine contextual information,
wherein the one or more intermediate media frames are further determined based, at least in part, on the contextual information.

18. An apparatus of claim 17, wherein the contextual information includes, at least in part, spatial information, temporal information, information regarding recognized objects, or a combination thereof.

19. An apparatus of claim 11, wherein the apparatus is further caused to:
wherein the at least one first media frame, the at least one second media frame, or a combination thereof includes, at least in part, one or more video frames, one or more audio frames, or a combination thereof.

20. An apparatus of claim 11, wherein the at least one first media frame, the at least one second media frame, or a combination thereof is an end media frame, a start media frame, or a combination thereof.

21-48. (canceled)
